(19) United States
(12) Patent Application Publication
(10) Pub. No.: US 2005/0143965 A1
(43) Pub. Date: Jun. 30, 2005

(54) Deterministic computation of radiation doses delivered to tissues and organs of a living organism

(76) Inventors: Gregory A. Failla, Gig Harbor, WA (US); John M. McGhee, Los Alamos, NM (US); Todd A. Warcing, Gig Harbor, WA (US); Douglas A. Busnett, Pattersonville, NY (US)

Correspondence Address: OLYMPIC PATENT WORKS PLLC, P.O. BOX 4277, SEATTLE, WA, 98104, US

(21) Appl. No.: 10/910,239

(22) Filed: Aug. 2, 2004

Related U.S. Application Data
(63) Continuation-in-part of application No. 10/801,506, filed on Mar. 15, 2004, now abandoned.
(60) Provisional application No. 60/454,768, filed on Mar. 14, 2003.
(60) Provisional application No. 60/491,135, filed on Jul. 30, 2003.
(60) Provisional application No. 60/505,643, filed on Sep. 24, 2003.

(51) Int. Cl. G06F 17/10

(52) U.S. Cl. 703/2

(57) ABSTRACT

Various embodiments of the present invention provide methods and systems for deterministic calculation of radiation doses, delivered to specified volumes within human tissues and organs, and specified areas within other organisms, by external and internal radiation sources. Embodiments of the present invention provide for creating and optimizing computational mesh structures for deterministic radiation transport methods. In general these approaches seek to both improve solution accuracy and computational efficiency. Embodiments of the present invention provide methods for planning radiation treatments using deterministic methods. The methods of the present invention may also be applied for dose calculations, dose verification, and dose reconstruction for many different forms of radiotherapy treatments, including: conventional beam therapies, intensity modulated radiation therapy (“IMRT”), proton, electron and other charged particle beam therapies, targeted radionuclide therapies, brachytherapy, stereotactic radiosurgery (“SRS”), Tomotherapy®; and other radiotherapy delivery modes. The methods may also be applied to radiation-dose calculations based on radiation sources that include linear accelerators, various delivery devices, field shaping components, such as jaws, blocks, flattening filters, and multi-leaf collimators, and to many other radiation-related problems, including radiation shielding, detector design and characterization; thermal or infrared radiation, optical tomography, photon migration, and other problems.

### CROSS REFERENCE TO RELATED APPLICATION

This application is a continuation-in-part of application Ser. No. 10/801,506, filed Mar. 15, 2004, which claims the benefit of provisional patent Application Nos. 60/454,768, filed Mar. 14, 2003, 60/491,135, filed Jul. 30, 2003 and 60/505,643, filed Sep. 24, 2003.

### TECHNICAL FIELD

The present invention is related to computer simulation of radiative transport, and, in particular, computational methods and systems for calculating radiation doses delivered to tissues and organs by radiation sources both external to and within a living organism.

### BACKGROUND OF THE INVENTION

In order to provide effective clinical radiotherapy treatments for human subjects, it is necessary to deliver an effective dose of radiation that is localized to a target area within the subject's body. Targets commonly include cancerous tumors and malignant cells and tissues, with radiation doses sufficient to kill malignant cells. Radiation-dose calculations are recognized as an important step in radiotherapy treatment planning and verification, and one which is often repeated numerous times in the development and verification of a single patient plan. The physical models that describe radiation transport through human tissues is highly complex, as a result of which most dose calculation methods in clinical use today employ approximations and simplifications that limit their accuracy and the scope of their use. Inaccurate dose calculation predictions can result in treatment plans having a lower tumor control probability and/or increased risk of post treatment complications. Variations of only a few percent in the delivered dose can be clinically significant.

The most common types of radiation therapy treatments include external beams, brachytherapy, and targeted radionuclides. Multiple variations exist for each of these modes. For example, photons, electrons, neutrons and protons (or other hadrons) can all be delivered through external beams. In addition, many variations exist in the method of beam delivery including, 3D conformal radiotherapy (“3D-CRT”), intensity modulated radiotherapy (“IMRT”), stereotactic radiosurgery (“SRS”), and Tomotherapy®. Brachytherapy treatments include photon, electron and neutron sources, along with a variety of applicators and other delivery mechanisms.

Radiotherapy treatment planning commonly involves generating a three-dimensional anatomical image by scanning and computational methods such as computed tomography (“CT”), magnetic resonance imaging (“MRI”) and positron emission tomography (“PET”). The data received from these methods are often reviewed and modified by a physician to identify anatomical regions of interest, to assign specific material properties, and to make any additional preparations for computational radiotherapy-treatment-planning analysis. Radiation-dose calculations are carried out on a hardware platform (e.g., a computer, server, workstation or similar hardware) and are generally performed on the computational anatomical representation to determine an appropriate dose deposition field. Multiple analyses are often performed to optimize treatment delivery parameters.

Monte Carlo has been widely recognized as the “gold standard” in dose calculation accuracy, and is currently considered by many to be the only method capable of accounting for all relevant transport phenomena in radiotherapy dose calculations. Monte Carlo methods stochastically predict particle transport through media by tracking a statistically significant number of particles. If enough particles are simulated, Monte Carlo will approach the true physical solution within the limits of the particle-interaction data and uncertainties regarding the geometry and composition of the field being modeled. However, Monte Carlo simulations are time consuming, limiting their effectiveness for clinical dose calculations. This is especially true in cases where a fine spatial resolution in dose is desired, such as for the treatment of small tumors or those in proximity to anatomical heterogeneities. In addition, with the adoption of image-guided radiotherapy, spatial precision is becoming increasingly important, and the time needed for dose calculations can be an important factor limiting further improvement of dose conformity. In treatment plan optimization, numerous dose calculations are often performed to establish trends resulting from small variations, or perturbations, in delivery. Due to statistical noise inherent in Monte Carlo simulations, these effects can be difficult to model without reducing the statistical uncertainty to a level well below that of the perturbation effects.

### SUMMARY OF THE INVENTION

Various embodiments of the present invention provide methods and systems for deterministic calculation of radiation doses, delivered to specified volumes within human tissues and organs, and specified areas within other organisms, by external and internal radiation sources. Embodiments of the present invention provide for creating and optimizing computational mesh structures for deterministic radiation transport methods. In general these approaches seek to both improve solution accuracy and computational efficiency. Embodiments of the present invention provide methods for planning radiation treatments using deterministic methods. The methods of the present invention may also be applied for dose calculations, dose verification, and dose reconstruction for many different forms of radiotherapy treatments, including: conventional beam therapies, intensity modulated radiation therapy (“IMRT”), proton, electron and other charged particle beam therapies, targeted radionuclide therapies, brachytherapy, stereotactic radiosurgery (“SRS”), Tomotherapy®; and other radiotherapy delivery modes. The methods may also be applied to radiation-dose calculations based on radiation sources that include linear accelerators, various delivery devices, field shaping components, such as jaws, blocks, flattening filters, and multi-leaf collimators, and to many other radiation-related problems, including radiation shielding, detector design and characterization; thermal or infrared radiation, optical tomography, photon migration, and other problems.

### BRIEF DESCRIPTION OF THE DRAWINGS

FIG. 1 shows a tessellated surface representation of a volume of interest.

FIG. 2 shows an illustration of a critical dose region.

FIG. 3 illustrates the computational mesh faces on a contoured structure prior to surface adaptation, where the element faces are more or less uniform in size.

FIG. 4 illustrates the results of surface adaptation where tetrahedral elements whose faces existing on regions of higher curvature are adapted as necessary to satisfy the specified deviation criteria.

FIG. 5 illustrates creation of a tetrahedral-element computation mesh using lofted-prismatic-layer conversion.

FIG. 6 illustrates the tetrahedral mesh generated from the surface adaptation shown in FIG. 4.

FIG. 7 illustrates computational mesh generation by anisotropic or isotropic adaptation.

FIG. 8 shows that element spacing may be applied separately for both internal (i.e. elements within a contoured structure) and external (i.e. elements outside of a contoured structure) biasing.

FIG. 9 shows sample computational mesh that illustrates an example where the CDR is defined manually and has been explicitly resolved by inclusion of the CDR surface representation in the mesh generation process.

FIG. 10 illustrates resolution of criteria conflict in favor of smaller sizes.

FIG. 11 shows a mesh in which the CDR representation is not enforced.

FIG. 12 shows a computational mesh for an electron transport calculation that includes additional elements.

FIG. 13 shows definition of the PTV perimeter.

FIG. 14 shows a surface is created to conform to the deliverable shape achievable by the field shaping devices.

FIG. 15 shows creation of additional surfaces where the perimeters of critical structures intersect the beam patch.

FIG. 16 shows specification of a grid of surfaces.

FIG. 17 shows a case in which surfaces that define gradients are not extended.

FIGS. 18 and 19 show cases in which inclusion of the beam surfaces can result in a computational mesh where element faces exist exactly on the beam surfaces.

FIGS. 20 and 21 illustrate anisotropic beam refinement.

FIG. 22 illustrates anisotropic beam refinement.

FIG. 23 shows the beam surface representations passing entirely through the anatomy.

FIG. 24 illustrates specification of element resolution by spacing and growth-rate factors.

FIG. 25 shows automatic creation of a critical dose region.

FIG. 26 illustrates an example where surfaces intersecting an organ at risk, such as that shown in FIG. 15, are created for only one of the beams.

FIG. 27 illustrates isotropic adaption along a central beam axis.

FIG. 28 illustrates explicitly modeling individual beam axes in the mesh generation process.

FIGS. 29 and 30 illustrate the results of isotropic adaptation based on source intensity and gradients.

FIG. 31 shows assigning each individual image pixel to a unique element.

FIGS. 32 through 36 illustrate the progression of adaptation.

FIGS. 37 and 38 illustrate sample meshes.

FIG. 39 illustrates gradients arising from applicator orientation.

FIG. 40 illustrates an alternative method in which several offset surfaces are created.

FIG. 41 illustrates a resulting layered mesh structure.

FIG. 42 illustrates analytic ray tracing to the Gaussian integration points on each element.

FIG. 43 illustrates creation of an optimized tetrahedral mesh for the applicator.

FIG. 44 illustrates inter-source attenuation. By modeling all sources simultaneously,

FIG. 45 illustrates a ray tracing approach to mitigate inter-source attenuation.

FIG. 46 illustrates collided flux components.

### DETAILED DESCRIPTION OF THE INVENTION

Although Monte-Carlo-based radiation does calculation is considered by many to be the only accurate method for computing radiation doses in human tissues, the Monte Carlo technique may be too computationally expensive for use in many applications, and may not provide desirable accuracy when the computations employ approximation necessary to carry out radiation-dose calculations within the time constraints imposed by real-word applications. An alternative to Monte-Carlo-based radiation does calculation is the deterministic solution of the Boltzmann equation that models radiation transport through materials. A common approach for calculating radiation doses using the Boltzmann equation is known as “discrete-ordinates.” This approach discretizes the radiation-transport problem in space (finite-difference or finite-element), angle (discrete-ordinates), and energy (multi-group cross sections), and then iteratively solves the differential form of the transport equation in a discrete, multi-dimensional space. Various embodiments of the present invention employ deterministic solution of the Boltzmann equation in order to compute radiation doses delivered to specified volumes within an organism, particularly the human body, as well as to many other radiation-related problems.

Radiation-does calculation in the context of radiotherapy planning involves a number of steps. A computational model of a volume including the treatment target is prepared, generally with physician-assisted or physician-specified target volumes, volumes for which radiation exposure needs to be carefully controlled, and volumes likely to be relatively insensitive to the exposure that occurs during radiotherapy treatment. The radiation source needs to be well characterized, and good parameters for the interaction of radiation with the various types of materials and tissues through which the radiation passes needs to be determined. A radiation-dose calculation can be performed for a given source, source position and geometry, and target model. The radiation-dose calculation may be repeatedly performed, with source positions and other parameters varied in order to determine a more optimal radiotherapy treatment plan.

Embodiments of the present invention include computational modeling methods and systems for producing computational models tailored for deterministic radiation dose computations and for computational efficiency and descriptive power. Additional embodiments of the present invention include discrete-ordinate methods for computing radiation fluxes in 3-dimensional volumes within exposed tissues and organs. General embodiments of the present invention include methods and systems for radian-dose computation and radiation-transport modeling. These embodiments are discussed below in several subsections, including a mesh-generation subsection, a radiation-transport-based computational subsection, and an implementation subsection that includes a Python-based implementation of a radiation-transport computational system that represents one embodiment of the present invention.

Computation Mesh Generation

The mesh-generation embodiments of the present invention are designed to provide a basis for an accurate radiation-transport-computation solution while minimizing the number of computational elements. A preferred embodiment uses variably sized and shaped tetrahedral elements. Tetrahedral elements include four-sided polyhedra, including tetrahedrons, and four-sided polyhedra with arbitrary edge lengths and internal angles. Tetrahedral meshes may accommodate rapid spatial variations in element size and orientation, providing the flexibility to locally use smaller elements where higher resolution is needed, and larger elements elsewhere. This is important in radiotherapy, where significant variations in the dose field often occur from gradients in the radiation source and material heterogeneities. Tetrahedral elements can accurately capture complex geometries using body fitted representations. Moreover, tetrahedral elements are well suited for adaptive meshing techniques. Because of the 3-noded faces on tetrahedral elements, face definitions are always uniquely defined, regardless of the level of element distortion. With faces having four or more nodes, such as hexahedral elements, face warpage may occur, limiting the extent to which these elements can be adapted. However, other types of computational elements may also be used, including polyhedra with more than four faces and with arbitrary edge lengths and angles. For computational efficiency, regular polyhedra with high symmetry are desirable.

In general, a preferred approach for radiotherapy planning and modeling incorporates adaptation to optimize the mesh structure. Adaptation of any discretized variable, such as the spatial resolution, angular quadrature order, scattering expansion polynomial order, and energy group resolution, can be performed prior to, or during the dose calculation. The local adaptation can be controlled by any number of parameters including, but not limited to, magnitude or gradients in the source, materials, or estimated errors in any of the computed variables or derived quantities.

In many cases, the local resolution needed for an accurate radiation-dose calculation in regions of clinical interest can be determined prior to radiation-transport-based analysis. A preferred embodiment may leverage this by adapting the element size and orientation based on proximity to critical structures, intensity gradients of the radiation source, and material composition, all of which may be determined prior to a multiple iteration transport calculation. In doing this, an optimal mesh structure may be achieved. Adaptation may also be performed during the transport calculation by iterating on gradients or estimated errors in any computed variables or derived. Adaptation before radiation-transport calculation and during radiation-transport calculation may be performed independently, or in concert, to minimize the total computational time. All of the adaptation processes described below for specific regions, such as capturing material heterogeneities, critical structures, and areas with high radiation doses or gradients, are interchangeable and can be applied to other features.

An initial step in radiotherapy-planning computation involves creating a computational mesh for external beam radiotherapy applications. Many of the discussed approaches can be directly transferable to brachytherapy and other radiotherapy treatments. In general, the process seeks to minimize the number of computational elements while retaining a high level of resolution in those areas of clinical interest. Although the methods presented below highlight the use of photon therapy, the methods described below are also applicable for electron therapy, and or other external beam modalities.

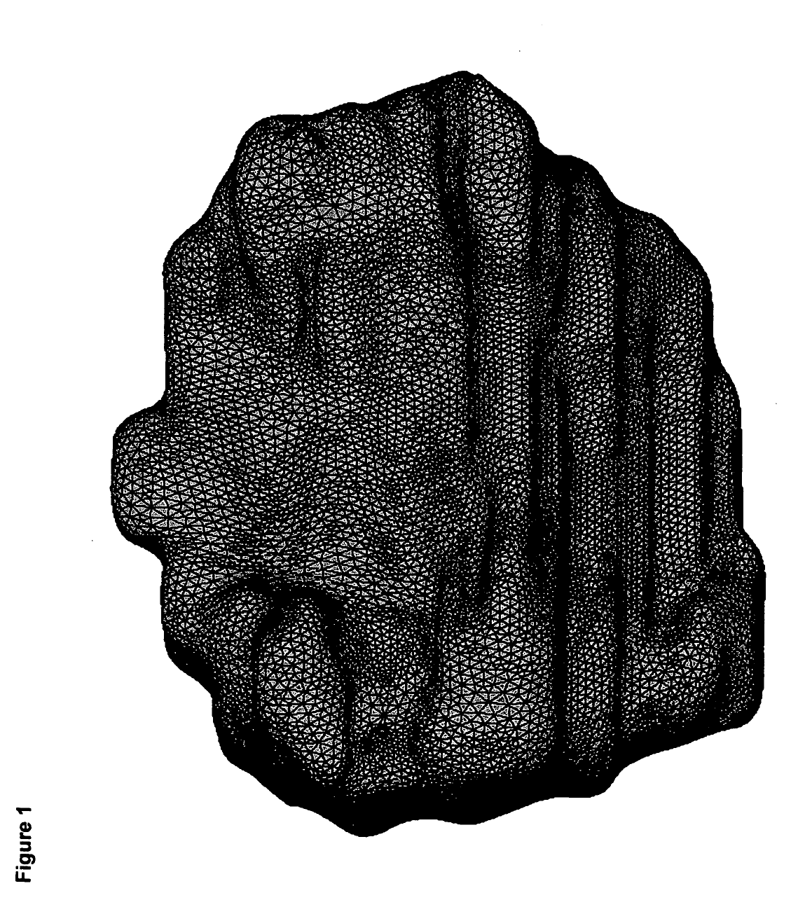

Important structures, also referred to here as volumes of interest (“VOI”), may include the planning treatment volume (“PTV”), organs at risk (“OAR”), and the patient perimeter, and are generally delineated prior to development of a treatment plan. Delineation commonly is carried out manually through CT simulation or treatment planning software. DICOM-RT is a common format used for storing both the original image data and VOIs. Once contoured, the VOIs are typically represented by closed loops in each imaging slice. When the slices are combined, the VOI may represent a closed solid body in pixilated format. This pixilated representation of a structure's bounding surface can be converted to a surface representation. The surface representation may be of any type, including tessellated formats consisting of triangular faces. FIG. 1 shows a tessellated surface representation of a volume of interest. The processes for doing this are familiar to those skilled in the art. A surface based format has the advantage in that it can provide a more continuous surface representation than is possible with stair-stepped pixilation. In a preferred embodiment, delineated structures will be converted to one or more surface representations and will be used as a constraint in the mesh generation process. This can enforce element faces to exist on the VOI structure surface, which will ensure that the VOI is accurately represented through an integer number of computational elements.

A next step involves delineation of critical dose regions (“CDR”). In this step, one or more volumes may be defined to encompass the regions of clinical interest for the dose calculation. This may generally include the PTV and adjacent critical structures, but may also include other areas where the dose is of clinical interest. The definition of CDRs both ensures that the element size and other adaptive solution parameters will be sufficiently well refined, as well as identifies regions where electron transport can substantially influence the dose to the VOIs. Since electron-mean-free paths are small compared with those of photons, it may not be necessary to calculate the electron transport in regions far away from those of clinical interest. Rather, it may be sufficient to perform electron transport on a sub-region of the initial computational mesh used for the photon transport. Alternatively, the electron transport can be performed on an entirely different computational mesh, where the electron source is interpolated to a new mesh structure.

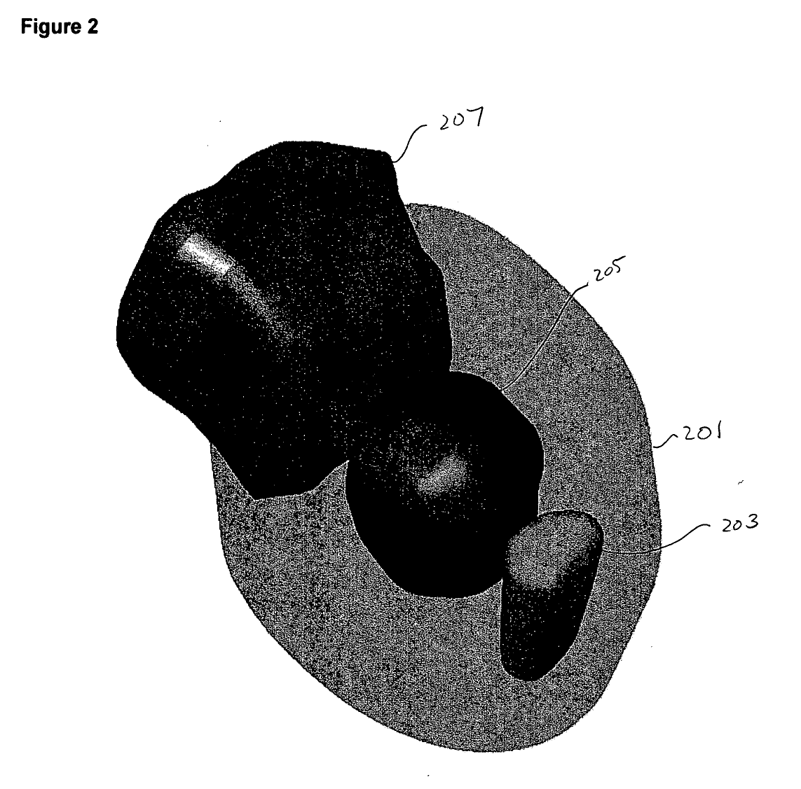

The CDRs can be created by contouring a region, slice-by-slice, in the same manner as is done for the VOIs. FIG. 2 shows an illustration of a critical dose region. The CDR 201 encompasses both the PTV 203 and a first OAR 205, and intersects a second OAR 207. The reason for the latter is that, with large structures, only a subset of an OAR may be considered close enough to be at clinical risk. Although the CDR is commonly manually defined, automated systems may be used to define the CDR, and alternative methods may also be used to determine the extents of the domain used for the electron transport calculation.

In a next step, and initial mesh is generated. In a preferred embodiment, the initial computational mesh may be created in this step, which can be independent of the beam treatment parameters. The bounding volume for the mesh generation process may generally be the patient volume obtained by the imaging process. Mesh generation constraints include the surfaces defined by the contoured VOIs, the patient perimeter, and optionally, manually defined CDRs. Nodes of element faces existing on these region boundaries may be mapped to the surfaces, which will result in an integral number of elements in each region, with no elements straddling more than one volume.

The following parameters may generally be applied to each VOI individually to govern the mesh generation process: (1) Element Edge Length, a parameter that specifies the target element edge length within an element, and that may also serve as a maximum permissible edge length; (2) Surface Adaptation Criteria—a parameter that specifies the maximum accepted deviation between a tetrahedral element face and the region surface it is associated with; (3) Element Spacing Normal to VOI Surfaces—a parameter that specifies the near wall element edge length normal to the VOI surfaces, which may be created through any number of methods, including lofted prismatic layers which may be converted to tetrahedral elements, or by any other means of anisotropic or isotropic adaptation, and which may be applied separately for both internal (i.e. elements within a contoured structure) and external (i.e. elements outside of a contoured structure) biasing; (4) Growth Rate of Element Spacing Normal to VOI Surfaces—a parameter that specifies the expansion rate of the element spacing normal to the surfaces, to which an additional parameter, specifying the maximum normal distance from the VOI surface to which adaptation is performed, may also be added, allowing for a more rapid transition of element size beyond the region where surface adaptation is performed; (5) CDR Element Edge Length—a parameter that specifies the maximum element edge length permitted within a CDR region, may be applied separately for each CDR; (6) Element Transition Rate—a parameter that specifies the spatial growth rate of elements from smaller to larger sizes; and (7) Maximum Global Element Size—a parameter that specifies the maximum element size permissible in the model, which generally occurs in the farthest regions from the critical structures.

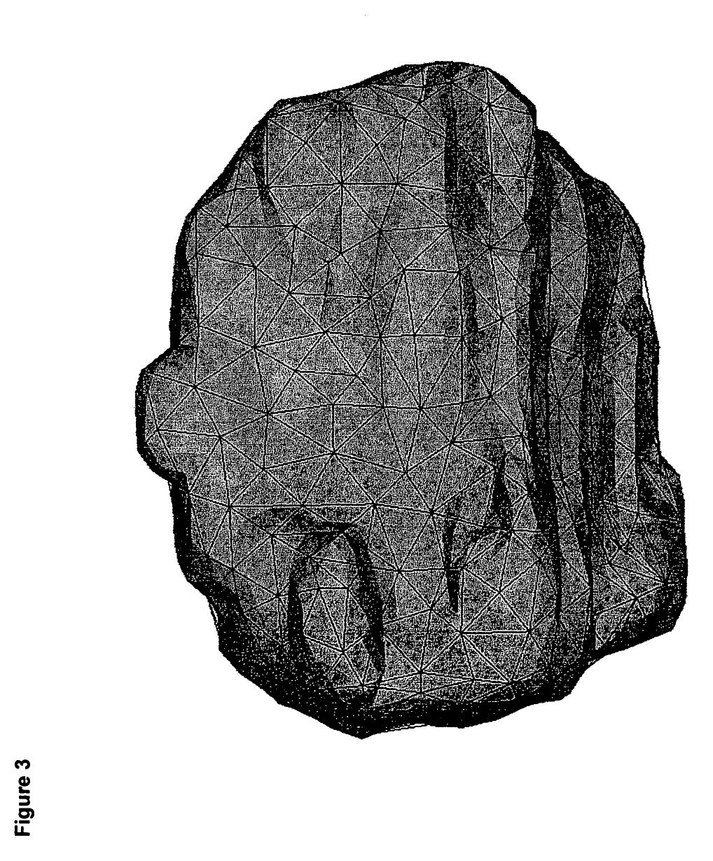

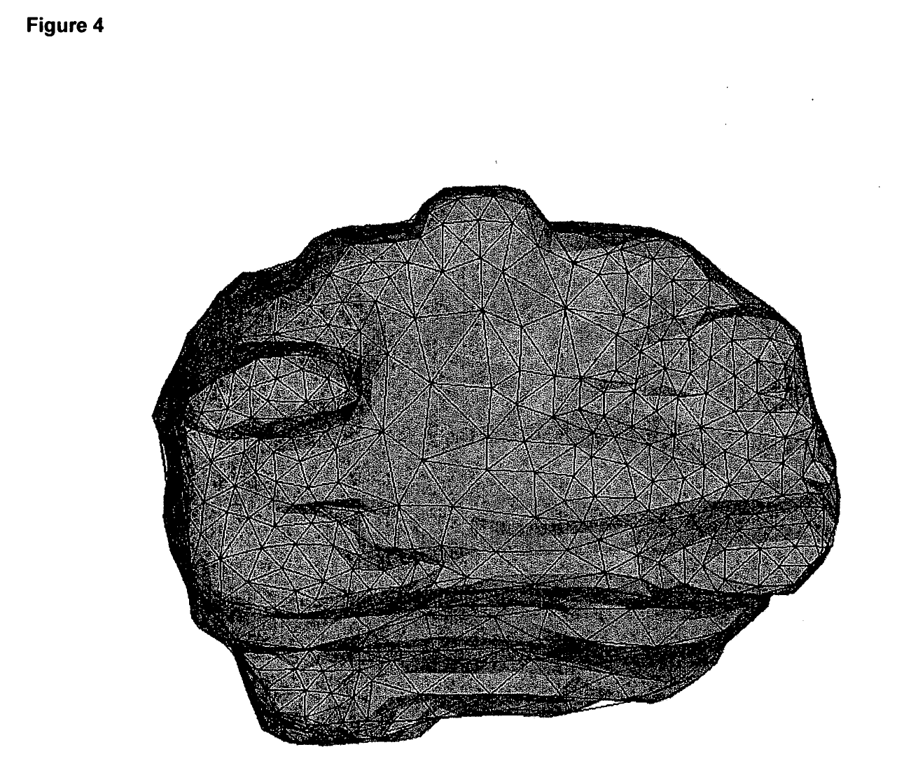

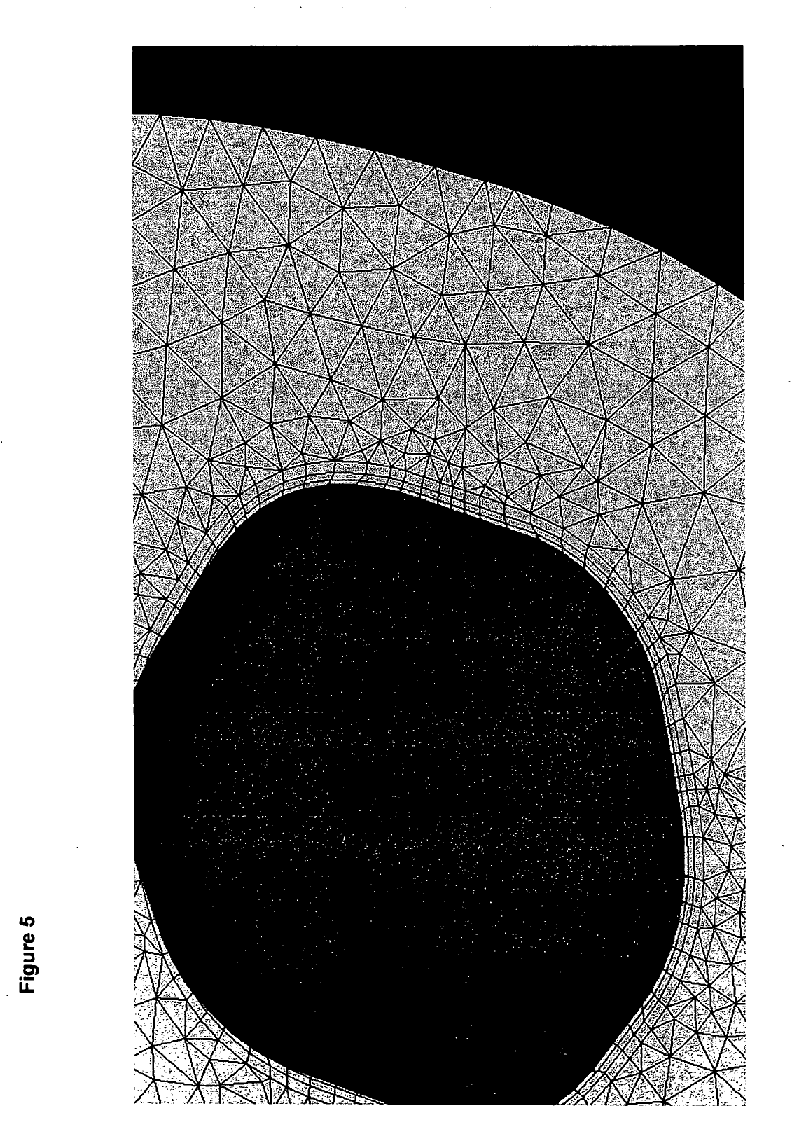

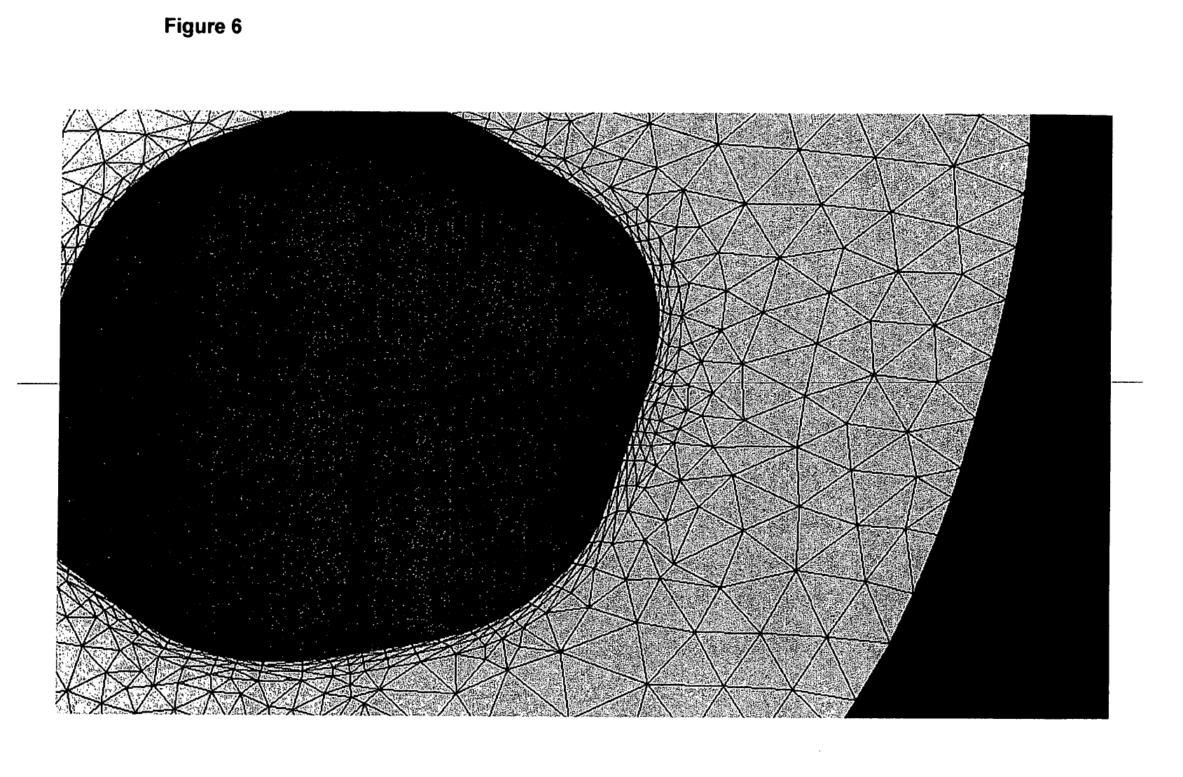

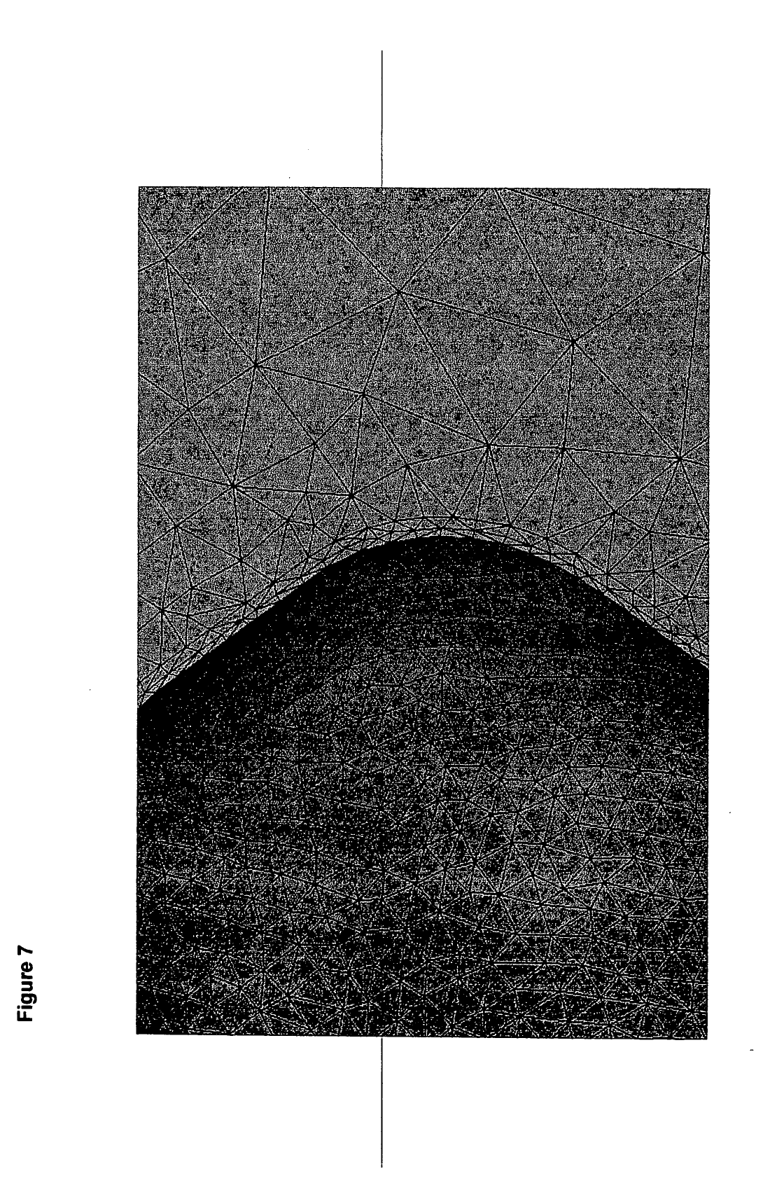

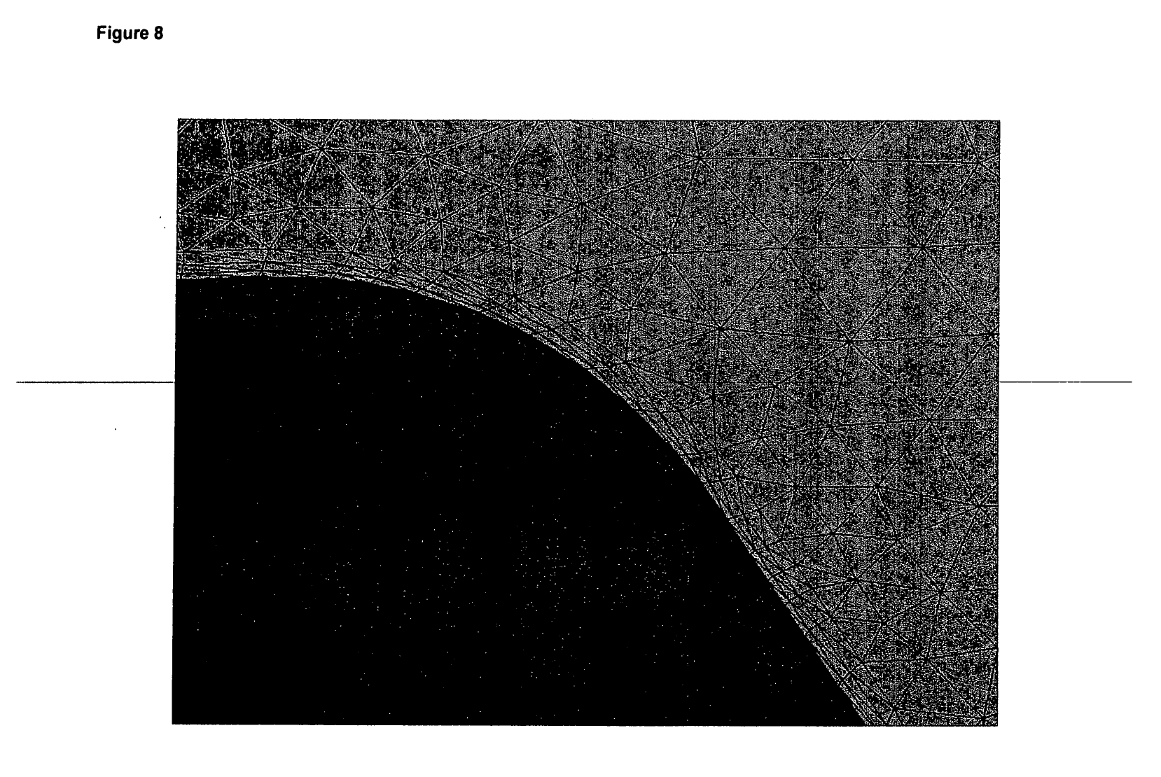

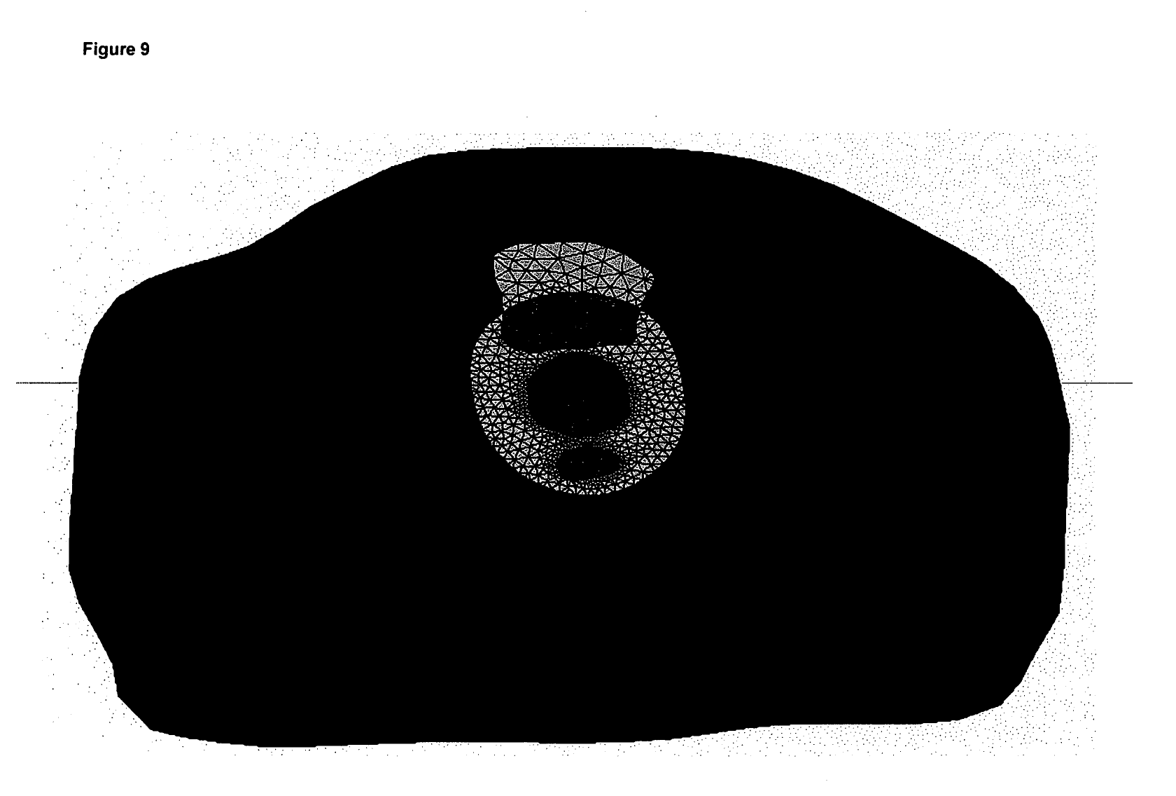

FIG. 3 illustrates the computational mesh faces on a contoured structure prior to surface adaptation, where the element faces are more or less uniform in size. FIG. 4 illustrates the results of surface adaptation. where tetrahedral elements whose faces existing on regions of higher curvature are adapted as necessary to satisfy the specified deviation criteria. FIG. 5 illustrates creation of a tetrahedral-element computation mesh using lofted-prismatic-layer conversion. FIG. 6 illustrates the tetrahedral mesh generated from the surface adaptation shown in FIG. 4. FIG. 7 illustrates computational mesh generation by anisotropic or isotropic adaptation. FIG. 8 shows that element spacing may be applied separately for both internal (i.e. elements within a contoured structure) and external (i.e. elements outside of a contoured structure) biasing. For clarity, FIGS. 5 through 8, and most of the following figures, illustrate the triangular faces of tetrahedral meshes on a planar surface intersecting the model. By enforcing element faces to exist on this plane, it enables an easier viewing of the underlying tetrahedral mesh structure. The presence of this plane, therefore, is only for visualization purposes of various embodiments and may not be explicitly included in clinical implementation. FIG. 9 shows sample computational mesh that illustrates an example where the CDR is defined manually and has been explicitly resolved by inclusion of the CDR surface representation in the mesh generation process.

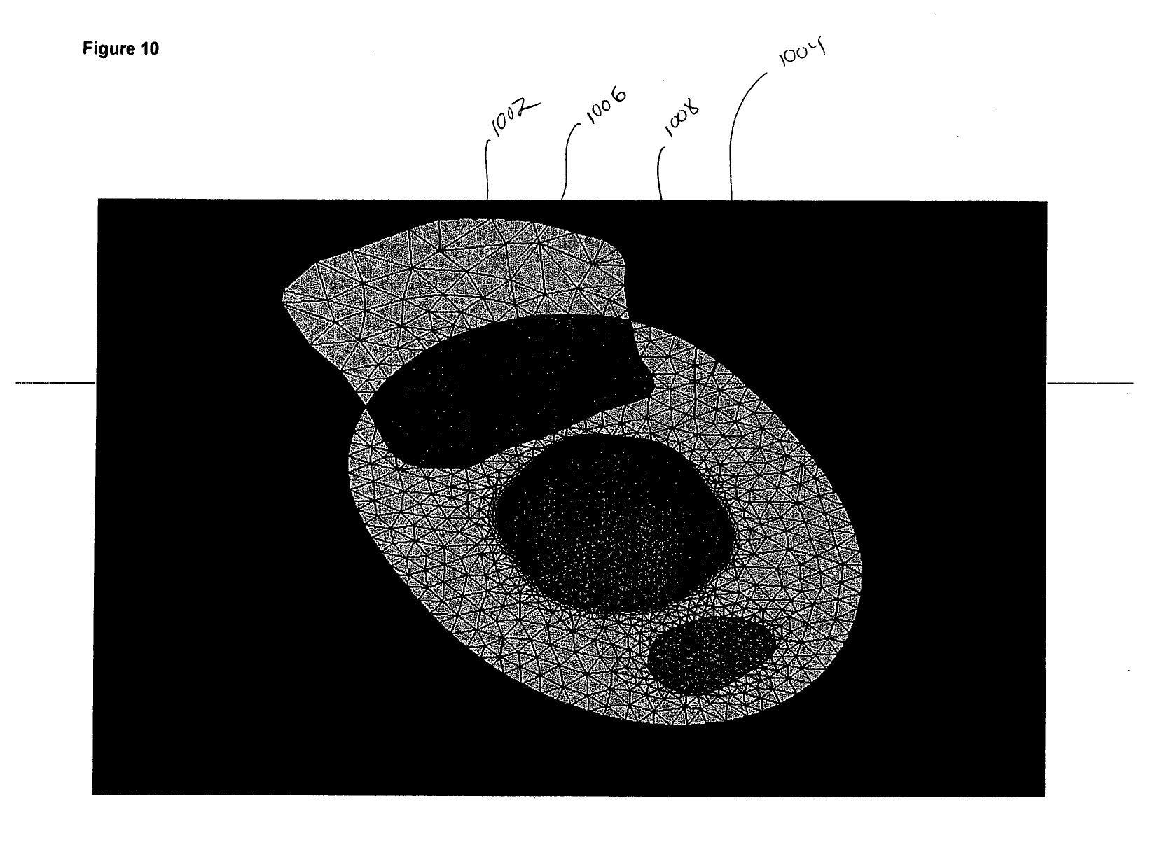

In general, when one or more of the above criteria conflict, the criteria providing the smaller size will be enforced. FIG. 10 illustrates resolution of criteria conflict in favor of smaller sizes. In FIG. 10, he maximum element edge length in a second OAR 1002 is larger than that specified in the CDR 1004. As a result, those elements within OAR 1002 that are outside the CDR 1006 have a larger element size than those within both OAR 1002 and the CDR 1004 (darker, intersection region 1008). All elements existing within a region are tagged as appropriate for identification. The mesh generation processes for implementing all of the above criteria will be familiar to those skilled in the art of mesh generation. Variations of methods for generating the tetrahedral mesh may include, but are not limited to, Advancing Front, Octree, and Delauney approaches.

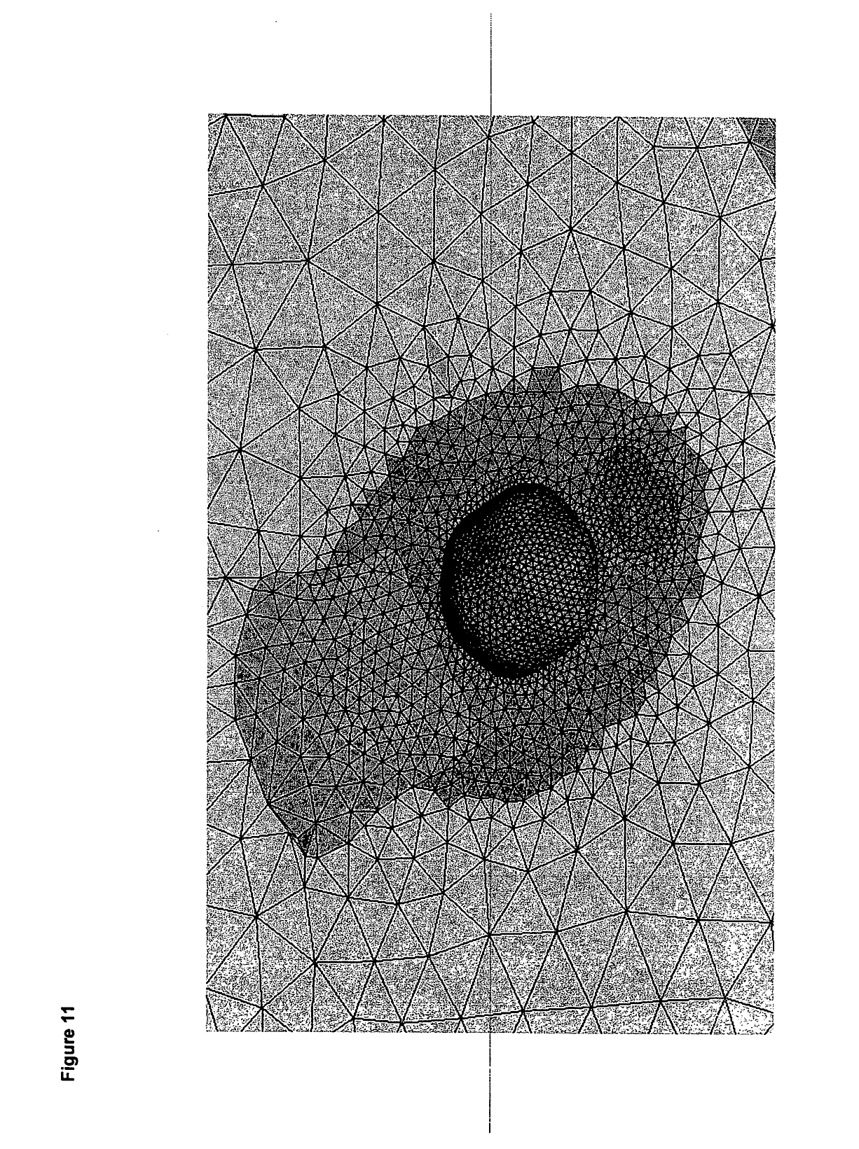

The sample computational mesh created with the above criteria shown in FIG. 9 illustrates an example where the CDR is defined manually and has been explicitly resolved by inclusion of the CDR surface representation in the mesh generation process. However, in a preferred embodiment, it may not be necessary to directly enforce the CDR boundary. Instead, elements existing partially or fully within this region may be refined according to criteria 5 above, but the CDR surface representation is not enforced. FIG. 11 shows a mesh in which the CDR representation is not enforced.

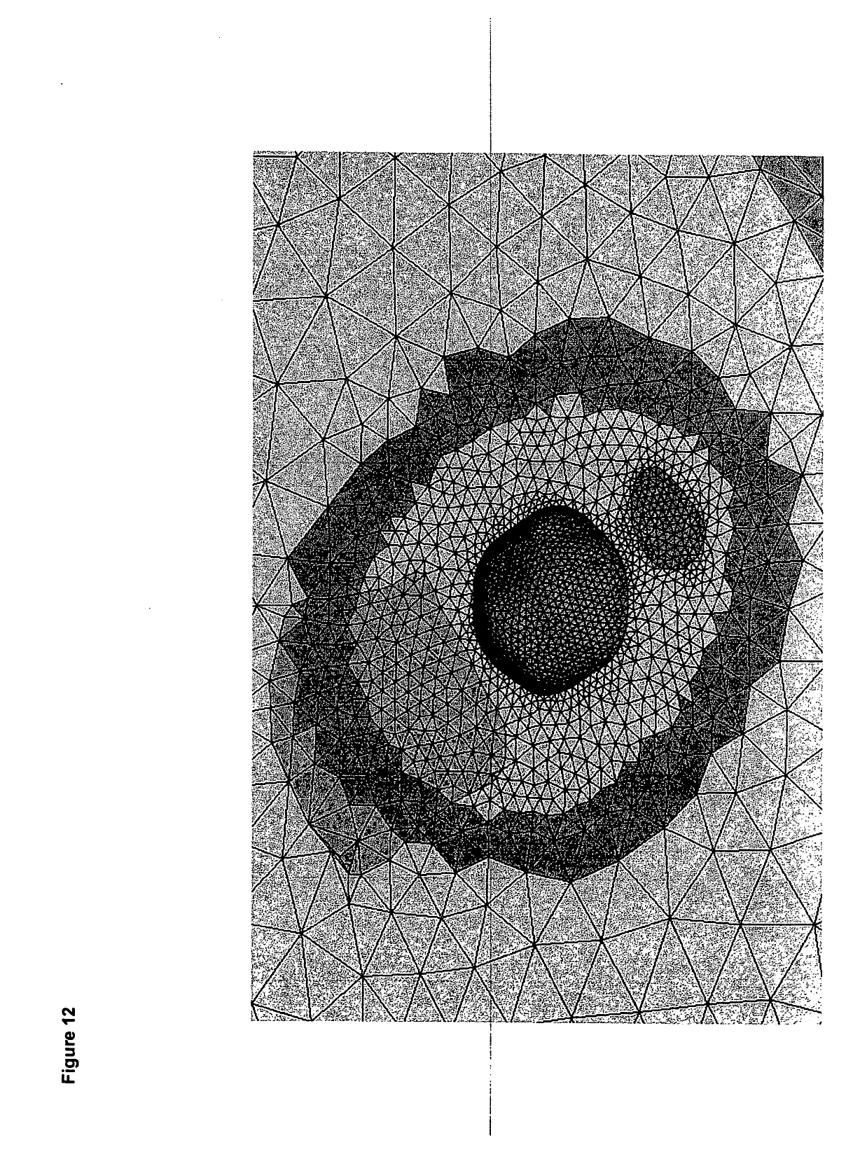

If the CDR, as shown in FIGS. 10 and 11, corresponds to the area for which the dose is of high clinical interest, the computational mesh for the electron transport calculation may include additional elements. FIG. 12 shows a computational mesh for an electron transport calculation that includes additional elements. This may be necessary to ensure that secondary electrons produced in proximity to the CDR, and which may substantially influence the dose field within the CDR, are transported. This distance, for which electron transport may be significant, may be based on a path length estimation, using ray tracing techniques, where the threshold distance is based on a electron mean free path estimate from any given element outside the CDR to a minimum distance, based on a mean free path, to the CDR. This allows for a variation in distance due to low density regions, such as air passages or lung, which can extend the distance from the CDR where electron transport is significant. Elements which exist within a threshold distance from the CDR may be included in a subsequent electron transport calculation. Alternatively, in the absence of a manually defined CDR, this approach may be used to determine which computational elements to include in a—subsequent electron transport calculation. Those elements identified for inclusion for an electron transport calculation may be flagged, as appropriate.

Through the steps provided above, the approach may enable the same computational mesh structure within the individual VOIs to be preserved for multiple treatment fractions or delivery modes. This is directly compatible with mesh generation approaches such as Advancing Front, which generate volume elements using previously created surface meshes as a constraint. In this manner, the surface mesh of the VOIs are preserved, as are all elements inside, and nodal connectivity is enforced with faces of volume elements outside of the VOIs. In this manner, multiple treatment fractions, which may combine various treatment modes, such as external beams and brachytherapy, can be performed using the same VOI mesh structure. This enables a more accurate representation of the cumulative dose without requiring interpolation between treatment fractions. Preserving the mesh connectivity within the VOIs can also be of benefit in cases where motion or deformation is present, either within or between fractions. For these cases, a deformation code may be used to deform the VOI volumes based on predicted or measured deformation. Methods to do this are familiar to those skilled in the art. Through adaptive tetrahedral elements, this deformation process is performed solely by moving individual nodes according to the deformation code results. This, in turn, eliminates the need to perform interpolation to sum up cumulative doses.

In a preferred embodiment, local element adaptation will be performed, in an isotropic or anisotropic manner, based on the radiation source intensity and gradients. It may be preferred that adaptation based on the source be performed prior to adapting on local material gradients. The level of refinement necessary for material gradients may be highly dependent on their location relative to critical structures and beams. Bones, air gaps, and other heterogeneities well outside the treatment field may not have a substantial effect on the delivered dose, and therefore may not require a fine resolution.

In a preferred embodiment, adaptation may be performed using one of two methods, or both of them in combination, which are described below. The objective is to adapt the computational grid created so that sufficiently refined elements exist in the regions where the highest source intensities and gradients exist. These principles are also generally applicable to brachytherapy and other radiotherapy treatments. The two methods include: (1) adaptation based on proximity and location relative to beam definition surfaces; and (2) adaptation based on gradient and intensity of the un-collided flux.

In adaptation based on proximity and location relative to beam definition surfaces, an objective is to adapt those regions of the anatomy that are swept by the beam paths or are in near proximity to gradients in the beam. In many cases, these regions can be determined once the beam directions are selected, prior to simulation. In general, the highest spatial intensity gradients produced by a beam will occur near the beam perimeters and in areas where a beam intersects a critical structure. This is especially true for IMRT, where the cumulative dose delivered from a single gantry position will be comprised of numerous delivered beam segments, each of which may correspond to different field shaping device positioning. The result is that the spatial intensity of the cumulative field can vary sharply around features such as critical structures within the beam path.

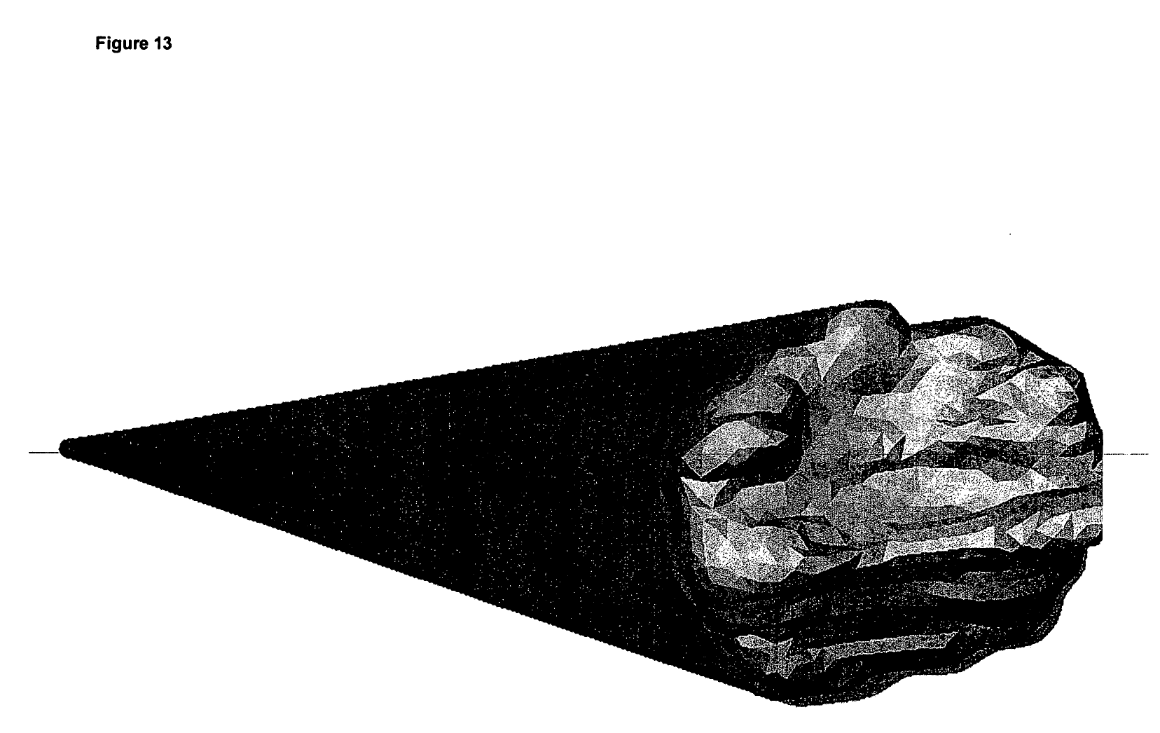

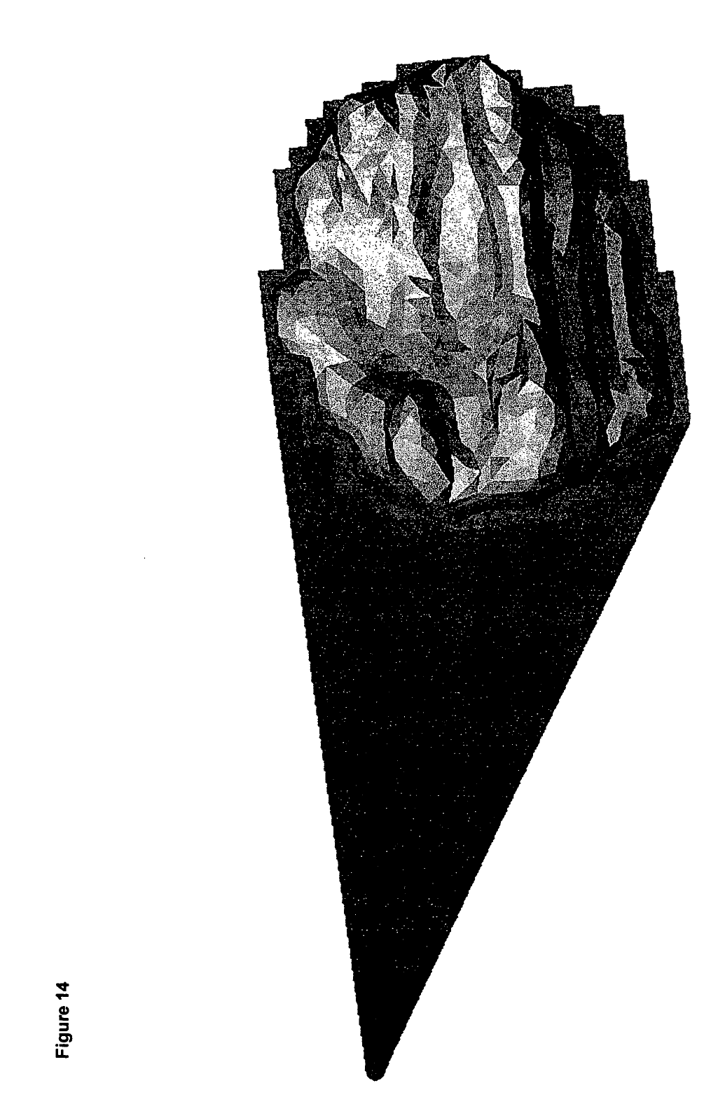

In general, the perimeter of a beam path from any given direction may be defined by the PTV perimeter as viewed from the selected beam position, back to the beam origin. FIG. 13 shows definition of the PTV perimeter. In many cases, the beam originates at a point source, which may be the target producing bremsstrahlung photons in a linear accelerator. The resulting surface definition can be created in any number of ways familiar to those skilled in the art. In another embodiment, a surface is created to conform to the deliverable shape achievable by the field shaping devices. FIG. 14 shows a surface is created to conform to the deliverable shape achievable by the field shaping devices.

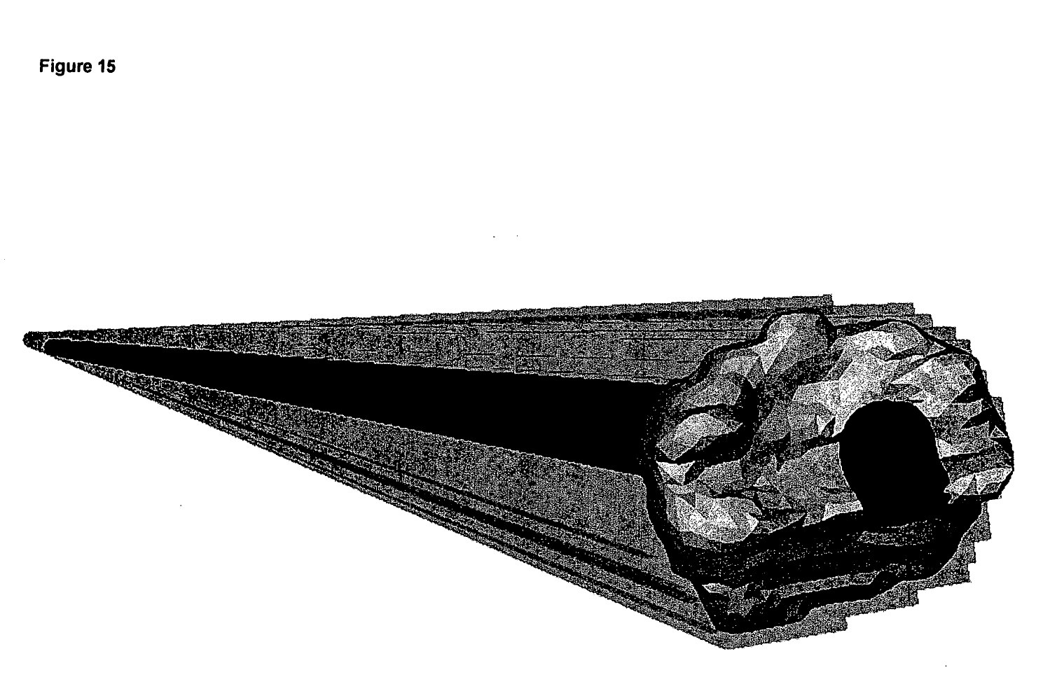

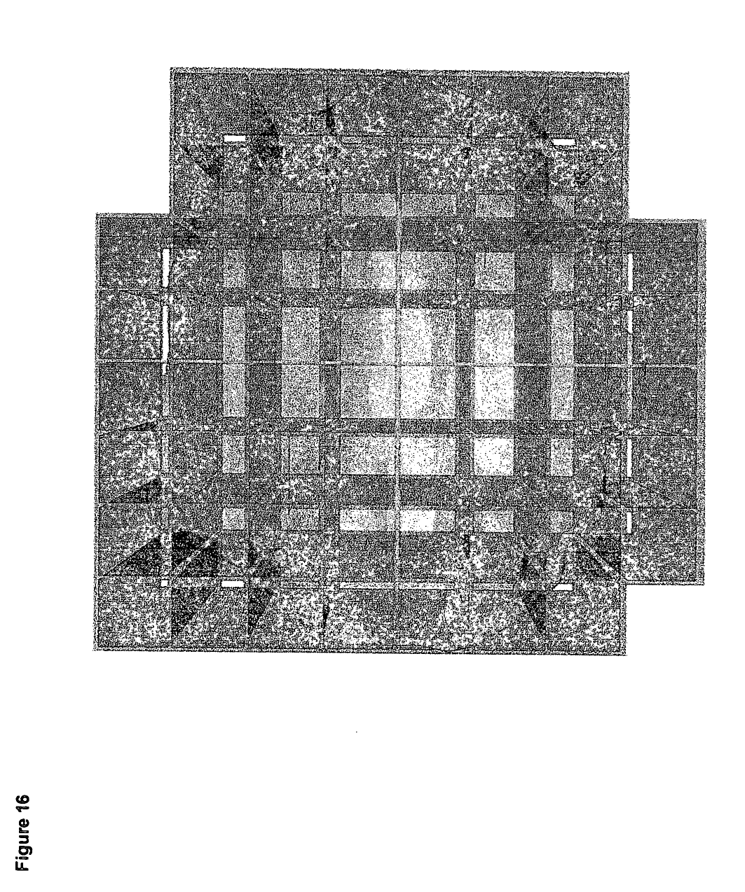

Additional surfaces can be created in a similar manner where the perimeters of critical structures intersect the beam patch. FIG. 15 shows creation of additional surfaces where the perimeters of critical structures intersect the beam patch. Another alternative is to specify a grid of surfaces. FIG. 16 shows specification of a grid of surfaces. This may be useful for optimization dose calculations, which are based on the superposition of pre-calculated beamlets, where the fluence from each separate beamlet calculation is confined to a single grid square.

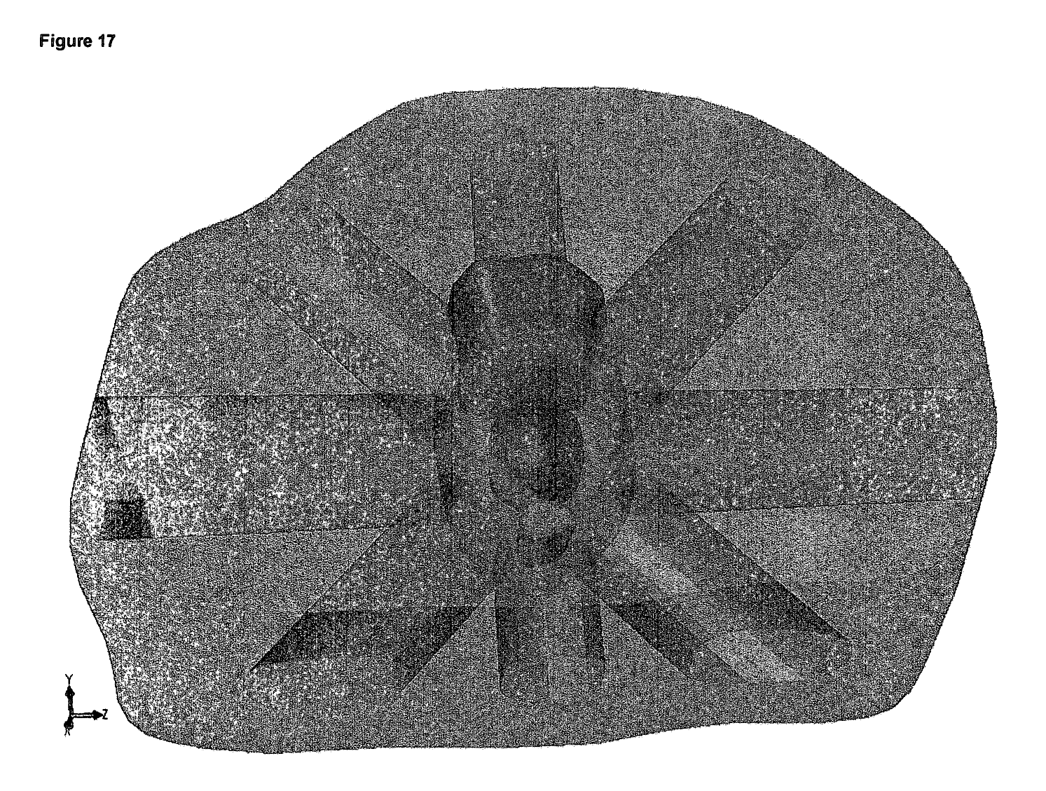

For anatomical calculations, the incident fluence may be predetermined and provided as input. In such cases, it may not be necessary to extend beam surfaces, including any surfaces used to define expected gradients resulting from the beam source, beyond the anatomical perimeter. FIG. 17 shows a case in which surfaces that define gradients are not extended. The beam surfaces are then used to drive a subsequent adaptation of those computational elements that are bounded by, or in the near proximity to, these surfaces. Explicit creation of surfaces may not be required, and some alternative formulation, such as an analytic description, may be used to define these regions, for adaptive purposes, which identify high gradient regions within the beams.

The selection of an embodiment for adaptation may be dependent upon the specific treatment modality. For cases where there are a relatively few number of beams, the beam surfaces can be explicitly added as constraints to the initial computational mesh generation process. An illustration of an embodiment of this geometry for this mesh generation process is shown in FIG. 17, where the beam surface geometries terminate at the CDR. This may be desired if the element sizes within the CDR are small enough to resolve the beam gradients without explicitly modeling the beam surfaces. Alternatively, the beam surface representations may pass entirely through the anatomy. Inclusion of the beam surfaces can result in a computational mesh where element faces exist exactly on the beam surfaces.

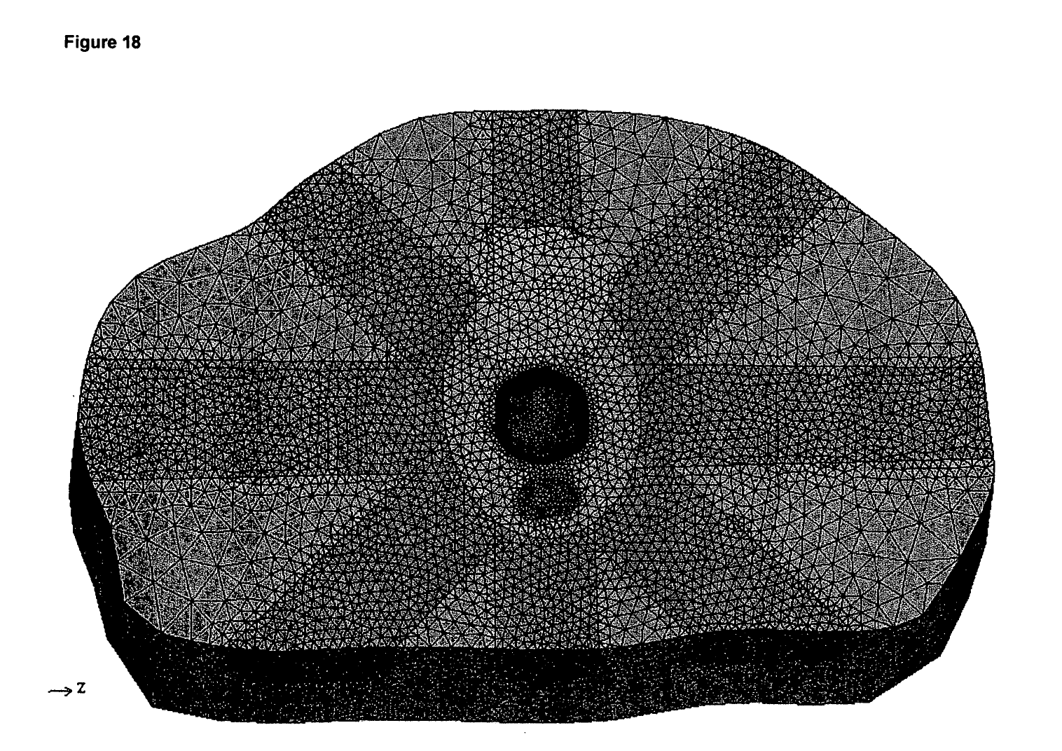

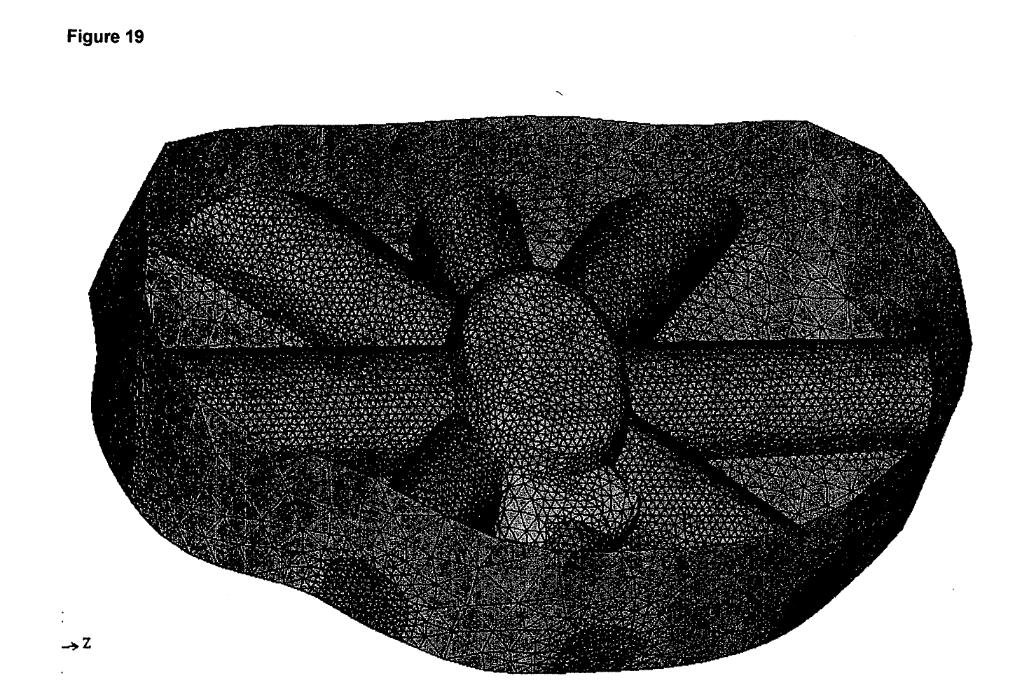

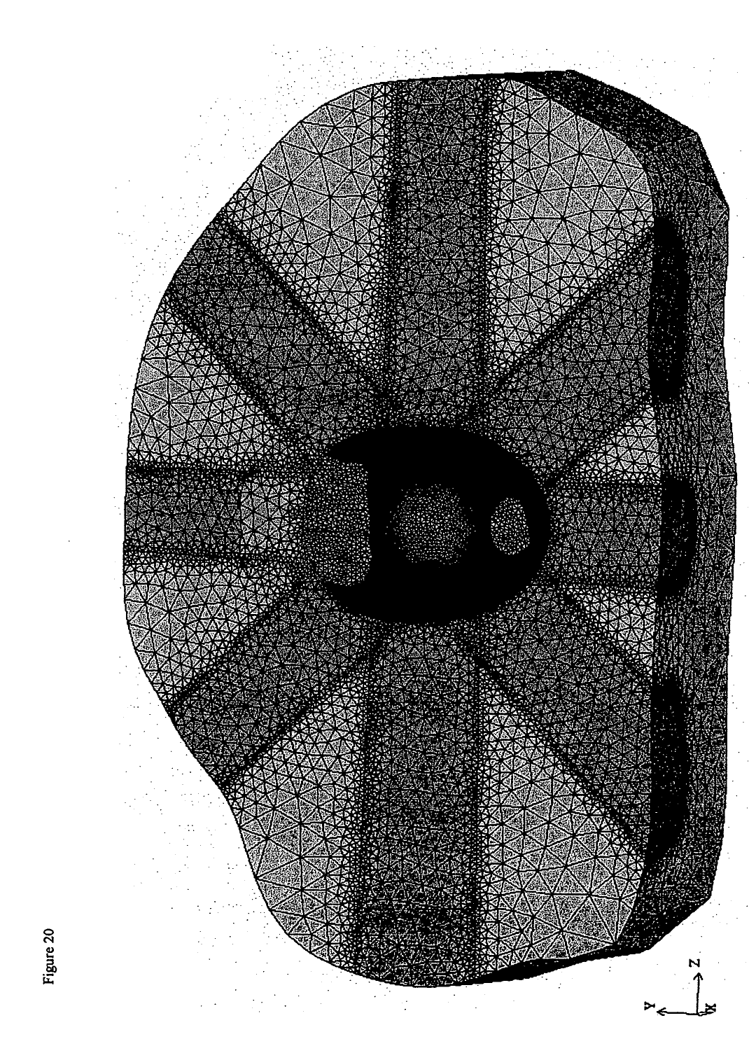

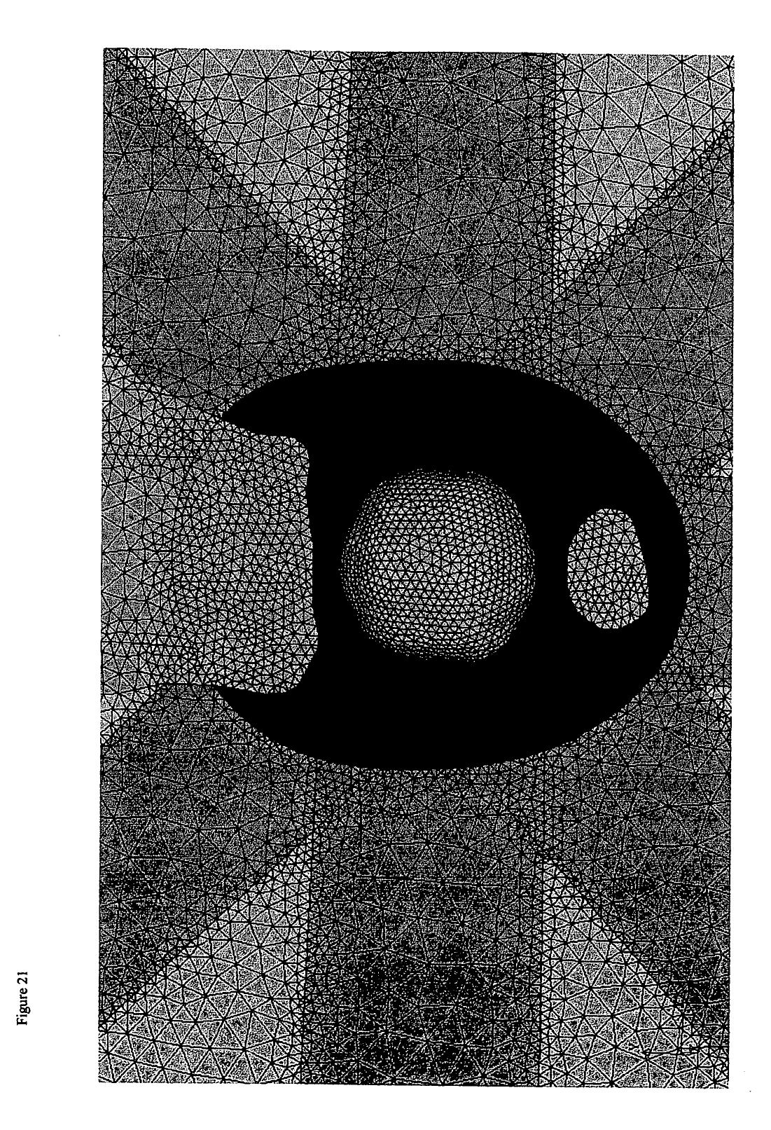

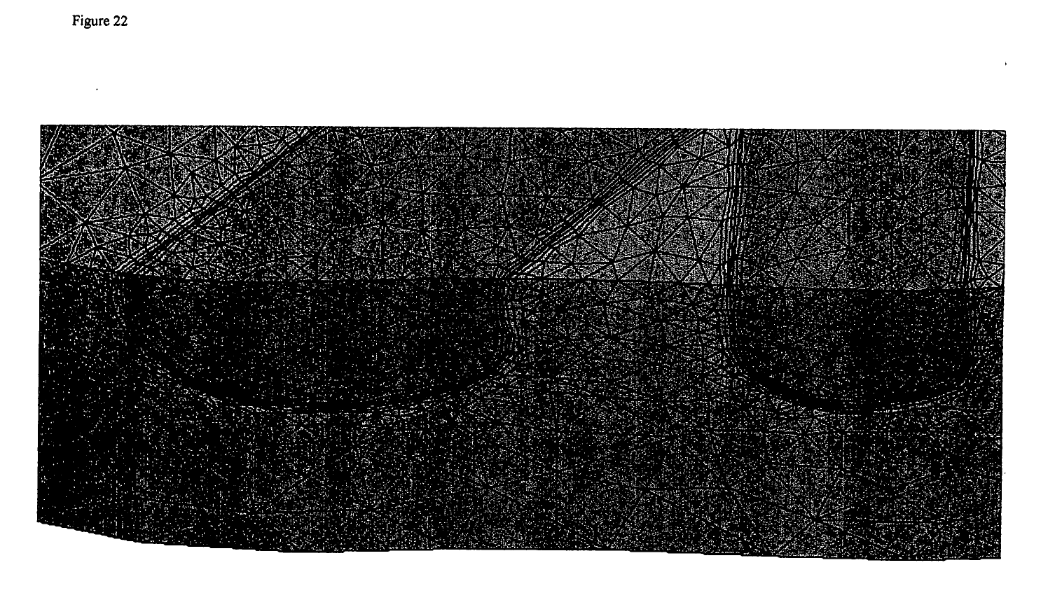

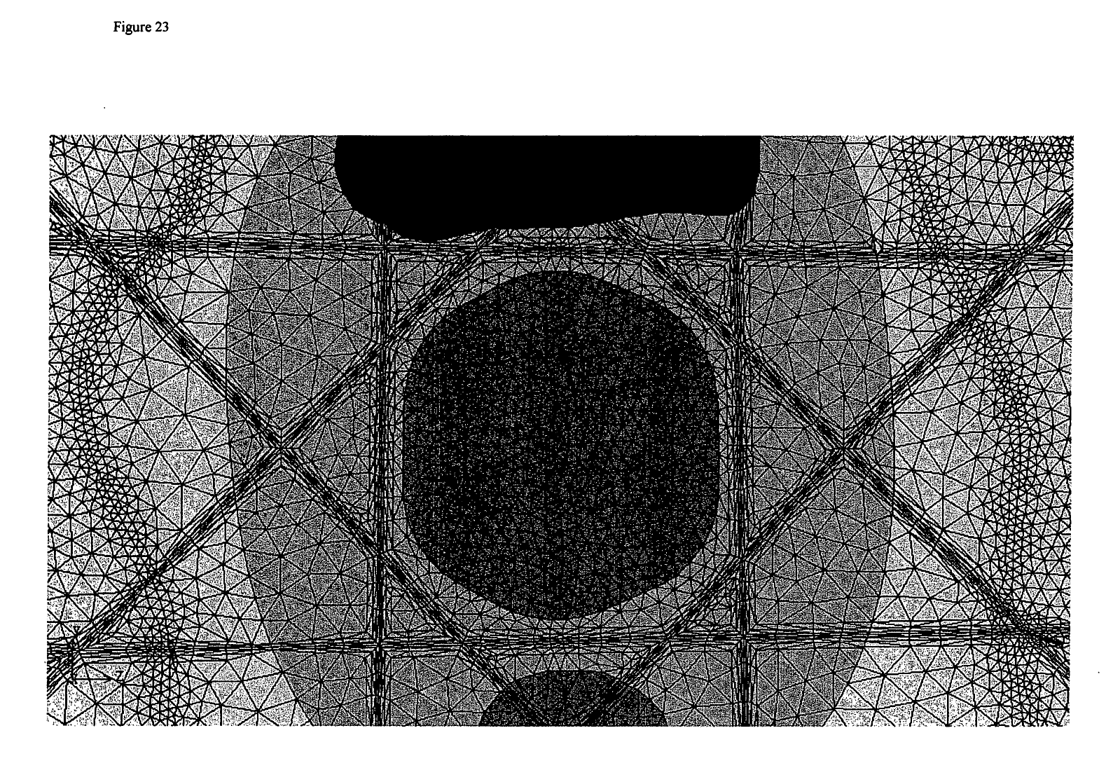

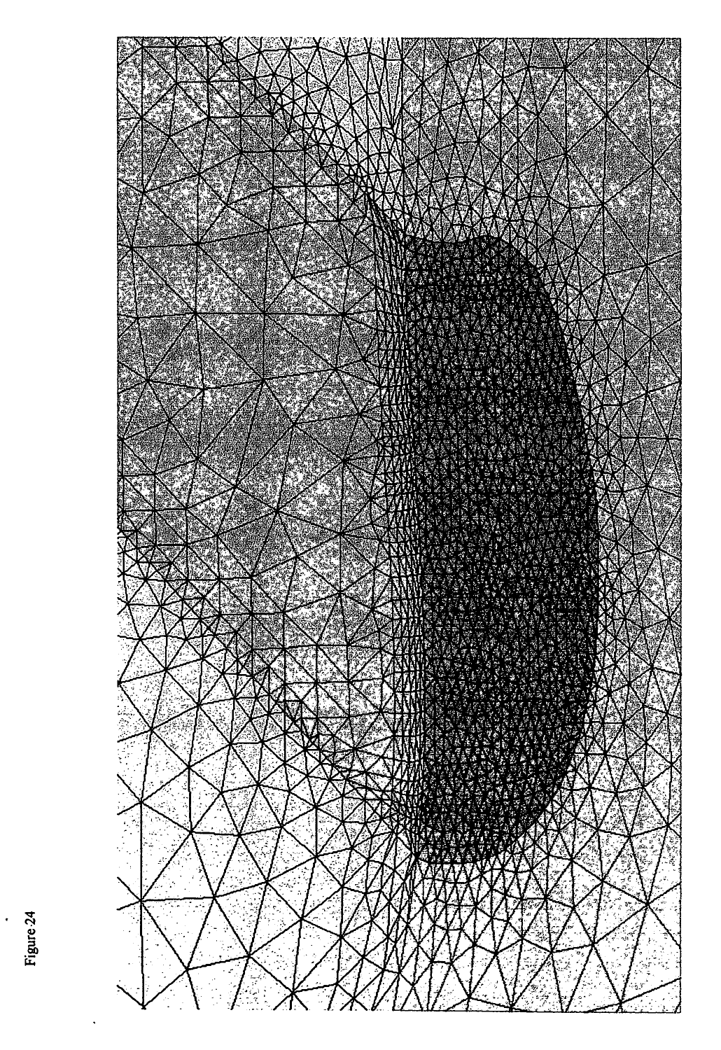

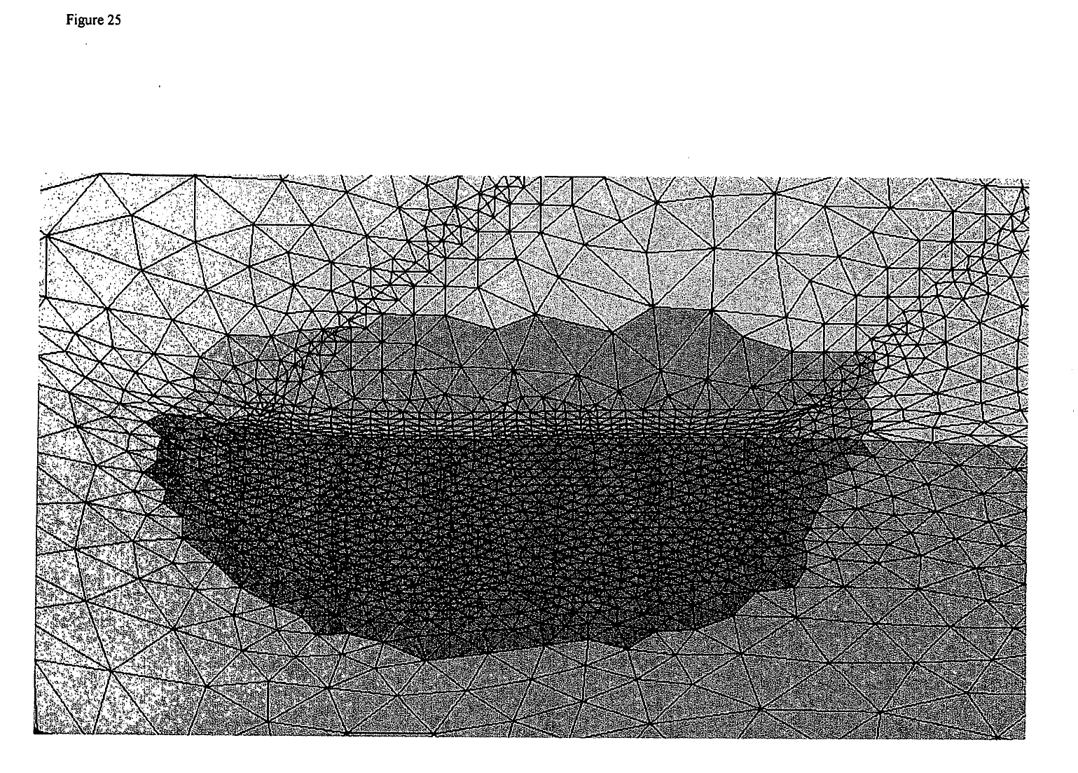

FIGS. 18 and 19 show cases in which inclusion of the beam surfaces can result in a computational mesh where element faces exist exactly on the beam surfaces. FIGS. 20 and 21 illustrate anisotropic beam refinement. FIG. 22 illustrates anisotropic beam refinement. FIG. 23 shows the beam surface representations passing entirely through the anatomy. FIG. 24 illustrates specification of element resolution by spacing and growth-rate factors. FIG. 25 shows automatic creation of a CDR region.

To create the computational mesh by adaptation based on proximity and location relative to beam definition surfaces, additional parameters may need to be specified to specify the resolution within and in the near perimeter to the beam: (1) Maximum Edge Length—a parameter that specifies the maximum permissible element edge length for elements existing within a beam which, as shown in FIGS. 18 and 19, in general enforces elements within the beam to be smaller than those outside; (2) Surface Adaptation Criteria—a parameter that specifies the maximum accepted deviation between a tetrahedral element face and a beam surface representation, not generally required to capture intersecting beam surfaces, such as those occurring in FIGS. 14 and 16, in which cases the mesh generation process may automatically enforce element edges to exist on curves defined by the location of intersecting surfaces; (3) Element Spacing Normal to Contoured Structure Surfaces—a parameter that specifies the element spacing normal to the beam surfaces, which may create isotropic or anisotropic elements oriented parallel to the beam direction; (4) Growth Rate of Spacing Specified in (3)—a parameter that specifies the expansion rate, which is commonly defined by an exponential growth, of the element spacing normal to the surfaces, to which an additional parameter governing the maximum distance from the beam surface to which adaptation is performed may also be added to allow for a more rapid transition of element size beyond the region where surface adaptation is performed, both parameters 3 and 4 able to be independently specified for both inwards and outward normal directions; (5) Element Transition Rate—a parameter that specifies the spatial growth rate of elements from smaller to larger sizes; (6) Element Spacing and Growth Rate in Build-up Region at Patient Perimeter—parameters that specify the element resolution in a build-up region arising from electron transport effects where a beam is incident on a patient, involving also automatic creation of a CDR region in the surrounding region, shown by tagged elements in FIG. 25, often resulting in multiple separate CDR computational regions used for electron calculations. Each of the above parameters may be independently assigned to individual surfaces, or to a group of surfaces, as appropriate.

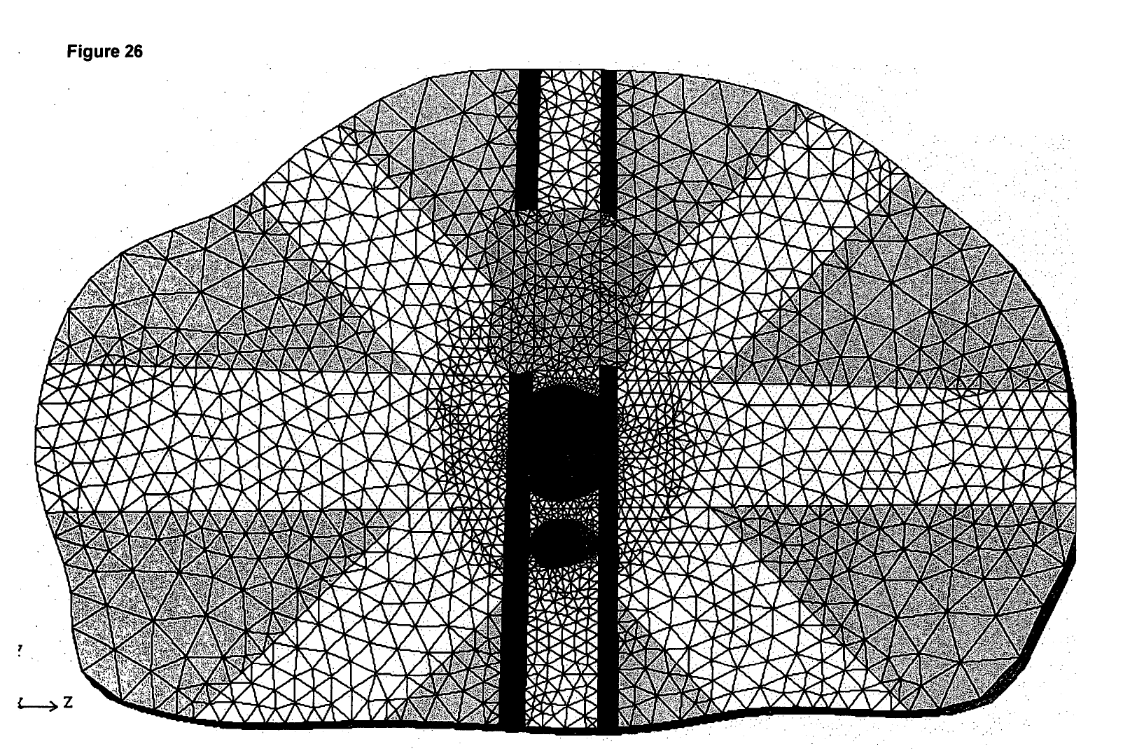

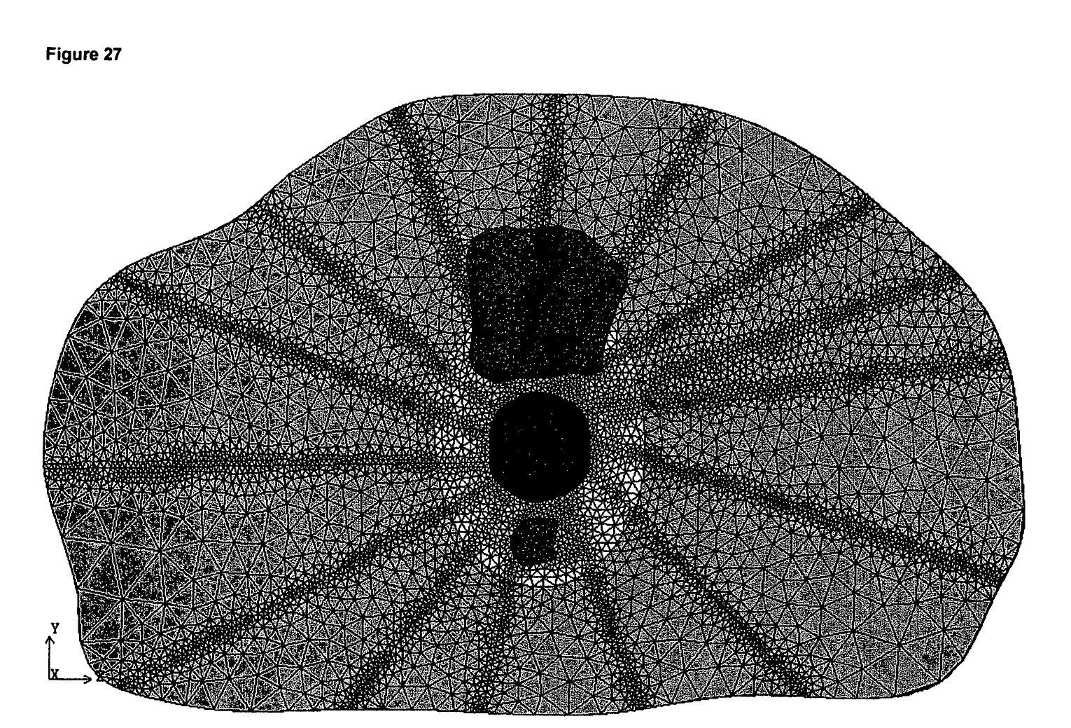

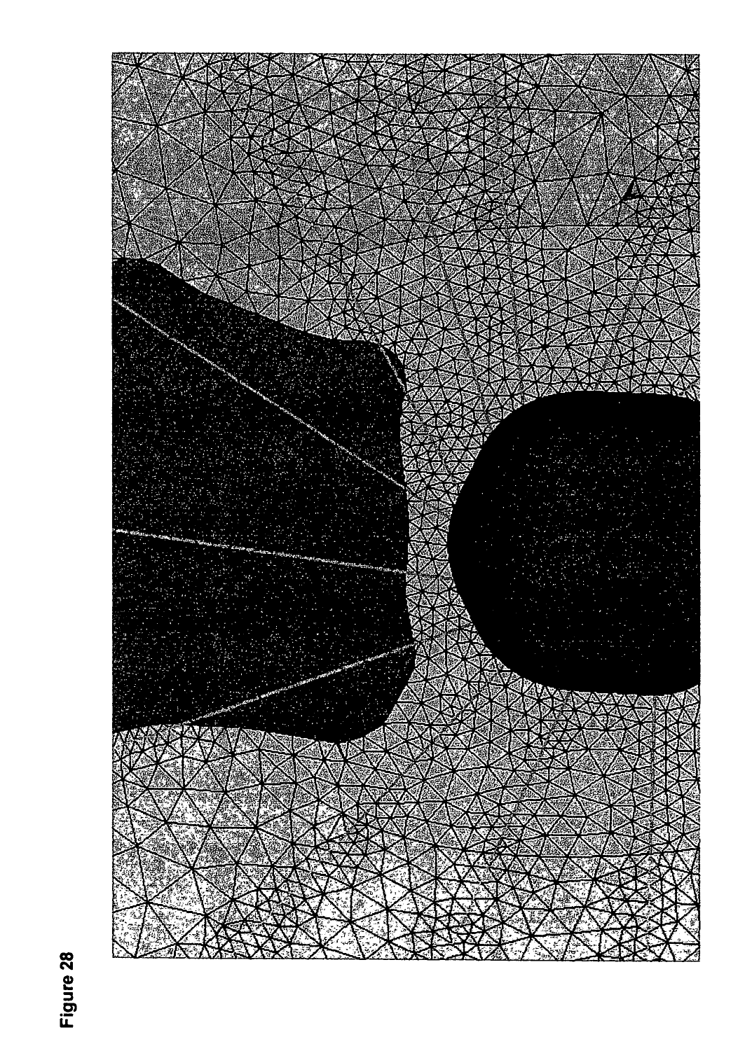

FIG. 26 illustrates an example where surfaces intersecting an organ at risk, such as that shown in FIG. 15, are created for only one of the beams. For cases where the beams are small, such as for stereotactic radiosurgery, it may be preferable to adapt along a central beam axis, rather than to explicitly model the beam perimeter surfaces. FIG. 27 illustrates isotropic adaption along a central beam axis. In FIG. 27, the elements in local proximity to the beam axis are selectively refined. Anisotropic refinement may be preferred, where the smallest edge lengths are normal to the beam axis. By explicitly modeling individual beam axes in the mesh generation process, element edges can be enforced to exist on the beam central axis, which may help to improve accuracy along the beam direction. FIG. 28 illustrates explicitly modeling individual beam axes in the mesh generation process.

An alternative to adaptation based on proximity and location relative to beam definition surfaces is to adapt the initial computational mesh based on the local magnitude and gradients of an uncollided flux calculation. An alternative to the uncollided flux may be used, but the uncollided flux is seen as advantageous since it provides a good measure of the source field gradients which are obtainable prior to initiating the full transport computation. In this manner, the level of local adaptation is directly dependent on the magnitude and gradient of the local uncollided flux within an element.

A straightforward process for performing an isotropic adaptation is next outlined. A first step is to assign various parameters that characterize adaptation: (1) EL_{magnitude}(region)—the target element edge length for adaptation based on the flux magnitude within an element, which may be dependent on the specific region, such as individual VOIs, CDRs, and regions external to CDRs; (2) EL_{difference}(region)—the target element edge length for adaptation based on the maximum variation in the flux magnitude within an element, which may alternatively be formulated as a gradient and may be dependent on the specific region; (3) Magnitude(region)—the minimum flux magnitude required for magnitude based adaptation to be performed, which may be region dependent and normalized based on the maximum flux found in the model from an uncollided flux calculation; and (4) Difference(region)—the minimum difference in the flux magnitude found in any element required for difference (or gradient) based adaptation to be performed, which may be region dependent and normalized based on the maximum flux difference found in the model from an uncollided flux calculation.

Next, the uncollided flux is calculated and magnitude based adaptation is implemented by: (1) calculating the uncollided flux, UCflux(ij), at each element, i, in computational domain at each quadrature point, j; (2) looping through each of the elements where the uncollided flux is calculated in order to (a) find the quadrature point where the maximum flux occurs, jₘₐₓ; (b) determine whether UCflux(ijₘₐₓ)≧Magnitude(region) for the region where element i is located; and (c) if UCflux(ijₘₐₓ) ≧Magnitude(region), and if the maximum edge length, ELₘₐₓ(i)>EL_{magnitude}(region), refine element i one level; (4) calculating the uncollided flux at each quadrature point for each new element that was created in step (3); and repeating steps (3) and (4) until the adaptive criteria has been satisfied for all elements.

Next, the adaptation is implemented for difference, or gradient, based adaptation by: (5) looping through all of the elements where the uncollided flux was calculated in step (1) to find the quadrature points where the maximum and minimum flux occur, jₘₐₓ and jₘᵢₙ, respectively and, when UCflux(ijₘₐₓ)−UCflux(ijₘᵢₙ)≧Difference(region) for the region where element i is located and the maximum edge length, ELₘₐₓ(i)>EL_{difference}(region), then refining element i one level; (6) calculating the uncollided flux at each quadrature point for each new element that was created in the previous step; and (7) repeating steps (5) and (6) until the adaptive criteria have been satisfied for all elements.

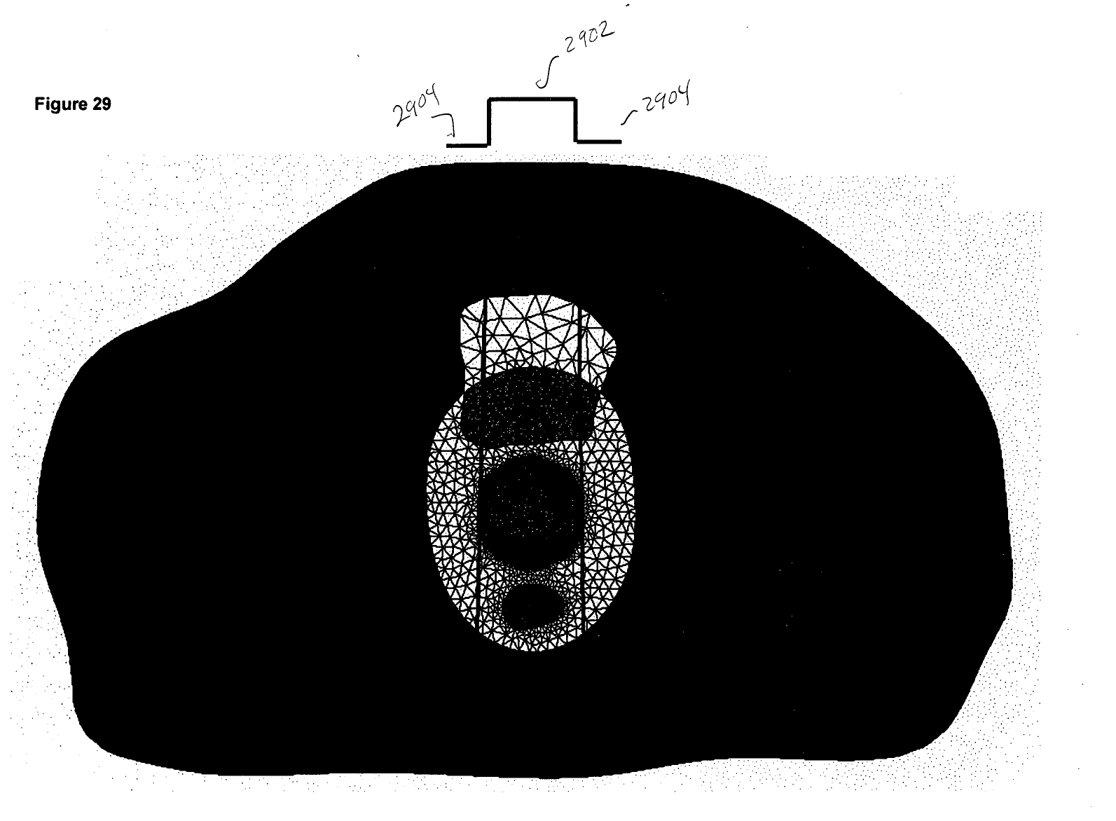

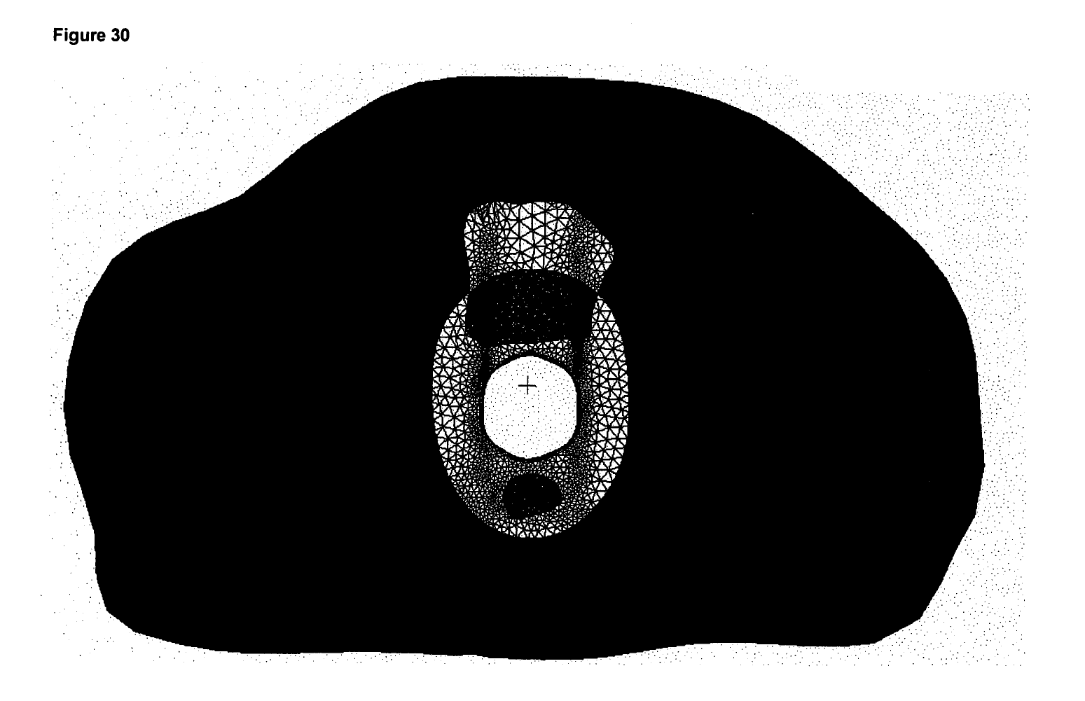

As shown above, since the finest resolution will generally be required in areas where steep gradients exist, a preferable means may be to first adapt based on magnitude and then on the difference, or gradient. In step 5, alternatively to looping through all of the elements in the model, gradient based adaptation could optionally be performed for only those elements which have been created in the magnitude based adaptation. FIGS. 29 and 30 illustrate the results of isotropic adaptation based on source intensity and gradients, as described above. The example considers a beam source having a flux of Ψₘₐₓ 2902 inside the beam, and 0 2904 immediately outside. Results of the adaptation are shown in FIG. 30. As shown, the level of local adaptation performed is dependent on the region, where higher refinement is performed inside the CDR. In the example shown in FIG. 30, smoothing is performed during and after refinement. The effect of this may be to reduce the spatial transition rate of element sizes away from the gradient. If smoothing is implemented, the uncollided flux calculation also needs to be repeated on any preexisting nodes which are moved during smoothing. A variety of smoothing options may be performed.

Alternatively, numerous more advanced adaptation methods can be implemented for the above, or for any other processes incorporating adaptation, which may include anisotropic adaptation based on directional gradients or other derived quantities, followed by adapting elements in the directions closest to the gradient normals. Also adaptation methods may use a combination of element refinement and/or coarsening, with anisotropic nodal movement to obtain an optimal structure. These adaptation techniques will be familiar to those skilled in the art of adaptive mesh generation. Adaptation based on proximity and location relative to beam definition surfaces and adaptation based on gradient and intensity of the un-collided flux, outlined above, may be used separately or in combination to obtain an optimal computational mesh structure.

The presence of anatomical heterogeneities, such as variations in tissue composition, air gaps, bones, lungs, and implants, can cause dose field perturbations that are clinically significant. Since these details may be highly irregular, they are often not manually delineated, as are the VOIs. Tetrahedral element sizes may be adapted based on local material properties. It should be noted that, for delineated structures, the material composition may be manually input for individual regions, such as VOIs, if appropriate. Alternatively, the adaptation processes can alternatively be used for adaptation inside VOIs containing material heterogeneities. This process may also be used for capturing delineated structures, such as VOIs.

As is conventionally done with Monte Carlo simulations for radiation therapy, CT numbers (or data produced by another imaging method) are converted to density and material values on a pixel-by-pixel basis. There are a variety of available methods for performing this conversion that are familiar to those skilled in the art. Once converted, a material image map of the patient results. In a preferred embodiment, this image map may then be used to drive the localized tetrahedral mesh adaptation.

The computational methods may also accommodate a higher order finite element representation of the density within each element. Here, material properties may be individually assigned to each quadrature point within an element. Finite element integration rules are used to define a linear, quadratic or other higher order representation within an element. Higher order finite element representation may reduce the level of refinement needed for material based adaptation.

The process for performing material based adaptation can be very similar to adaptation based on gradient and intensity of the un-collided flux. Parameters such as ELmagnitude, ELdifference, Magnitude, and Difference may be similarly defined, and may be region dependent. However, the difference and magnitude may be based on the density within each element, rather than the uncollided flux. An important component of this process is to spatially vary the required resolution on a region-by-region basis, or through some other criteria, which will base the level of refinement on whether or not material heterogeneities are located in, or proximal to, areas of critical interest. The steps of adaptation based on gradient and intensity of the un-collided flux may be performed in a similar manner to adapt on material heterogeneities, where magnitude based adaptation is performed prior to difference, or gradient, based adaptation. The uncollided flux calculation is replaced by a determination of the density composition within each element.

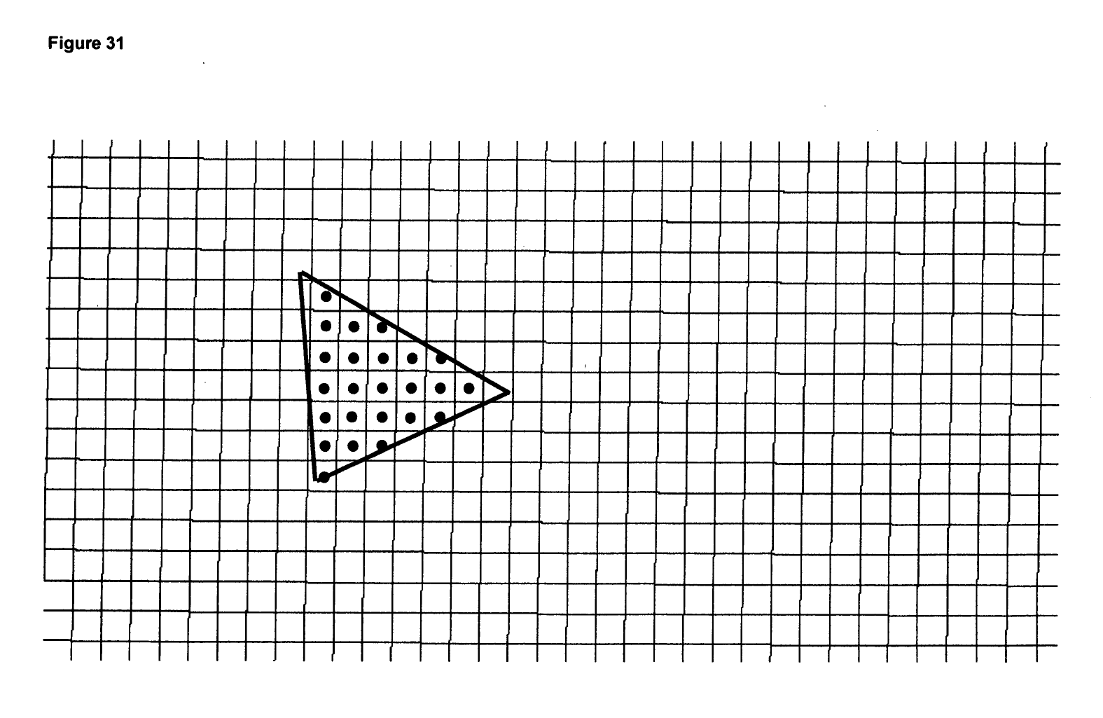

In a preferred embodiment, the density composition of each element may be determined by assigning each individual image pixel to a unique element. FIG. 31 shows assigning each individual image pixel to a unique element. In FIG. 31, those pixels marked with dots are contained within the element shown. If the element size is very small, it may be possible that no pixel centroid exists within the element, in which case a number of techniques may be employed, including averaging of the element density based on neighboring elements. In the simplest form, the maximum density within an element could be determined as the maximum density of any pixel whose centroid exists within that element. Likewise, the maximum density difference within an element could be determined as the difference between the maximum and minimum densities found in any pixels located within that element.

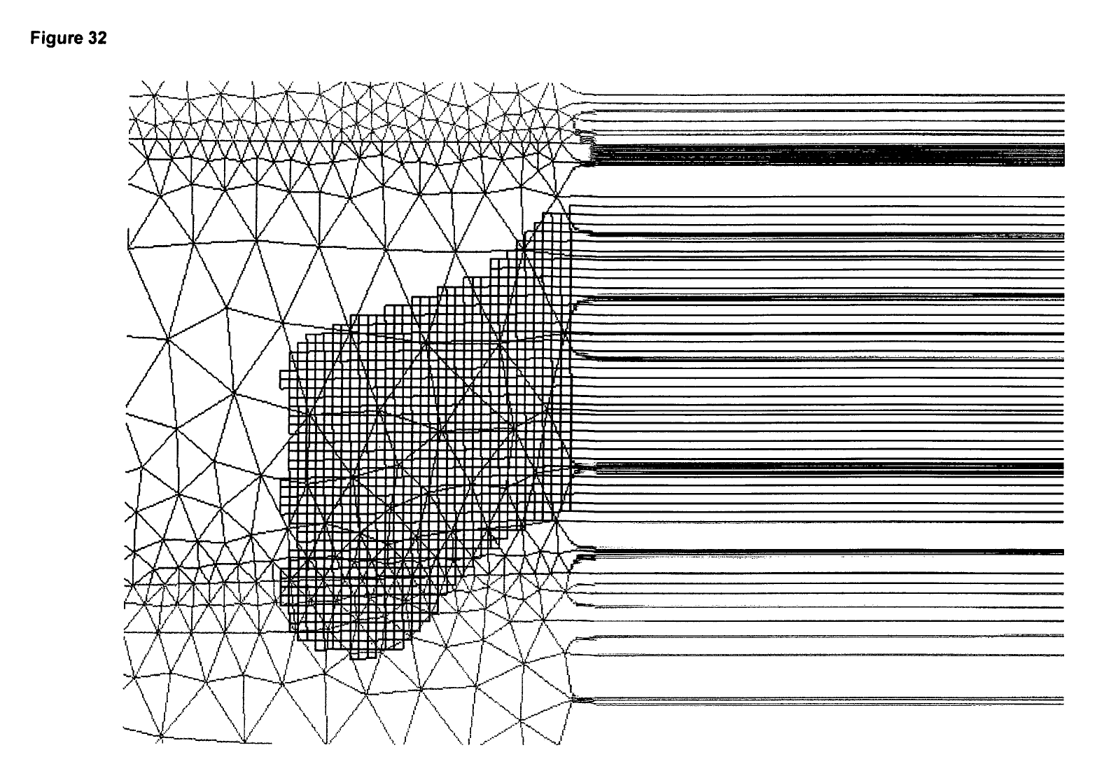

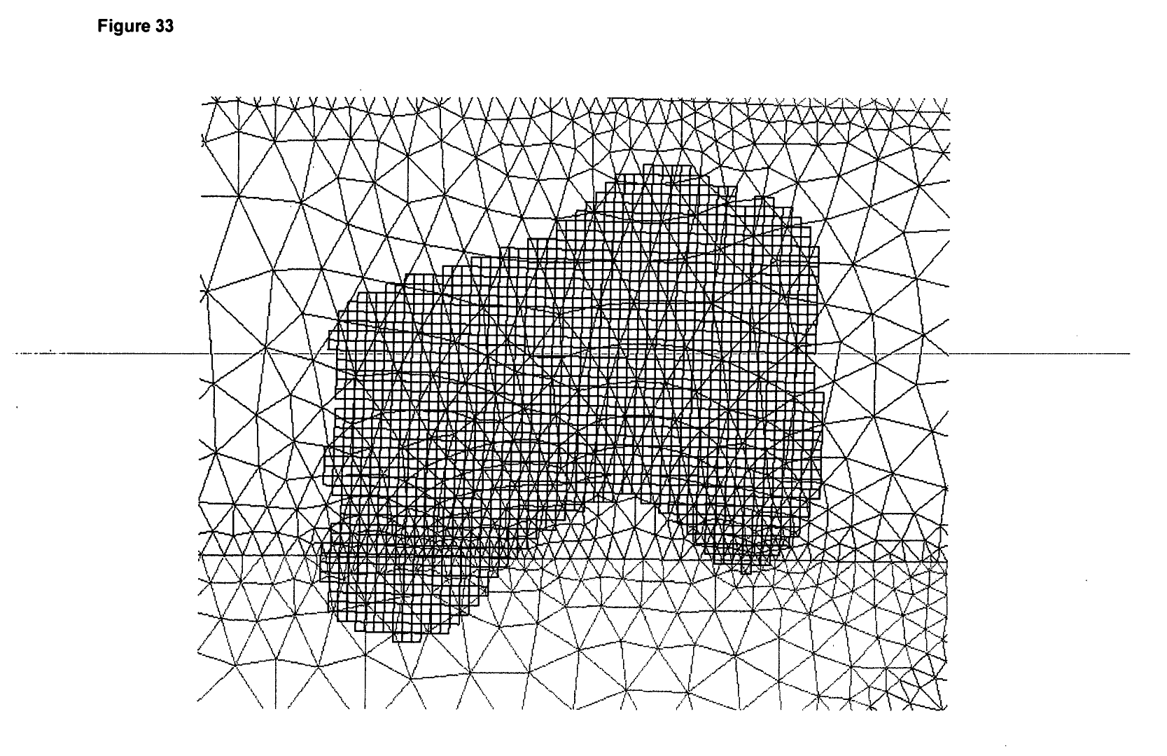

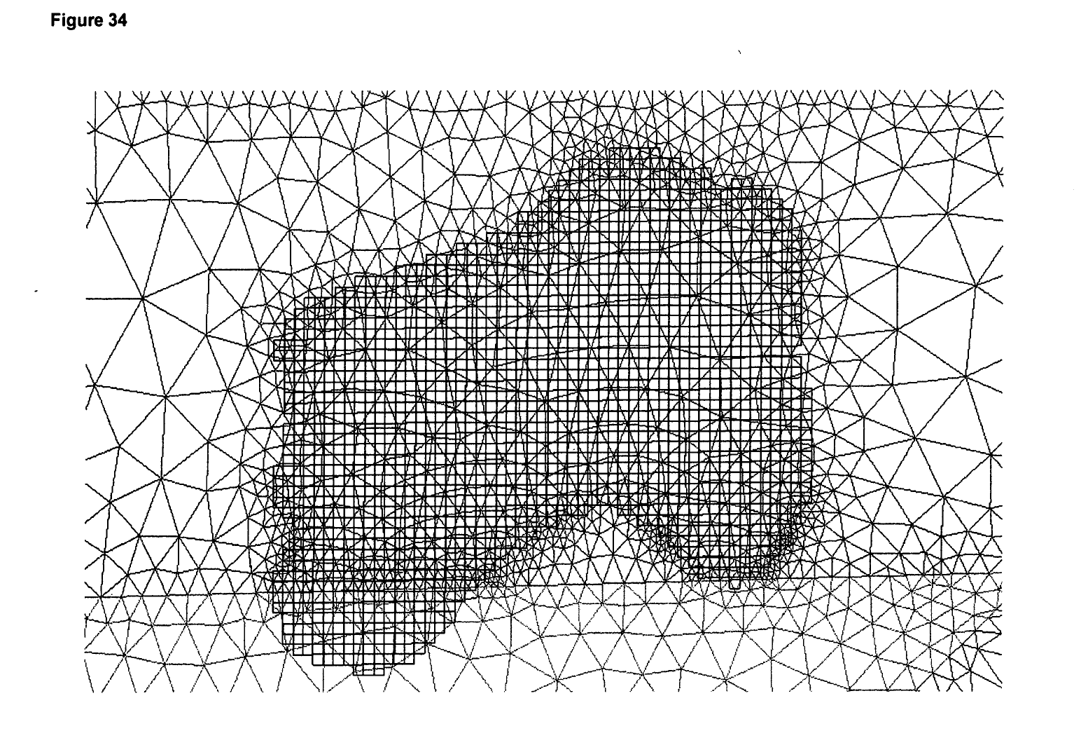

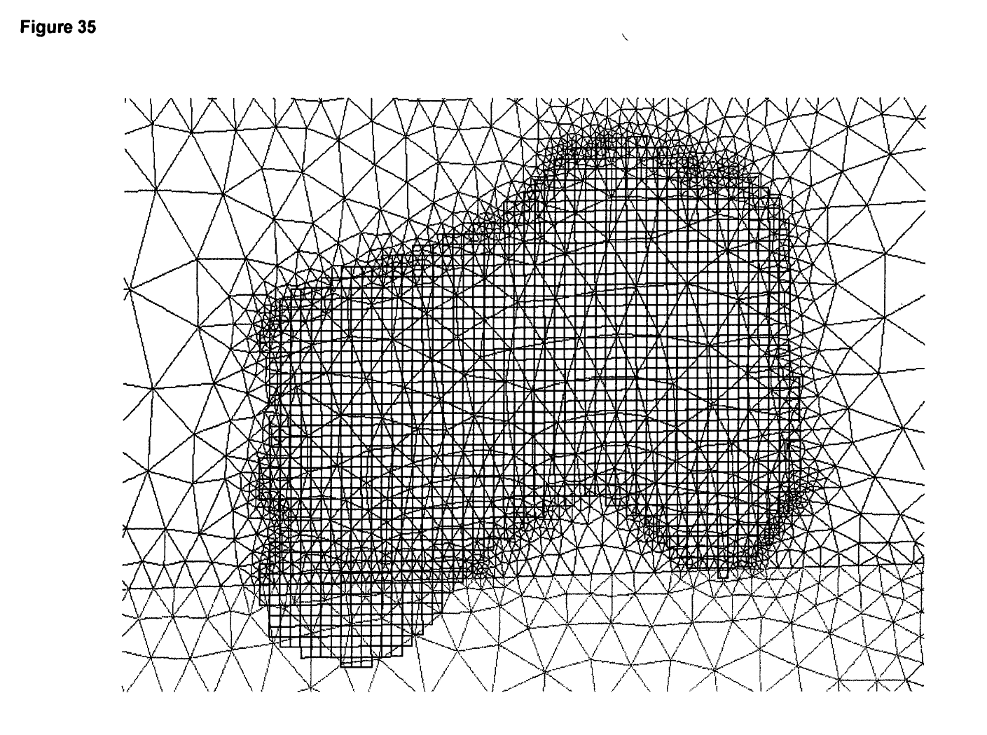

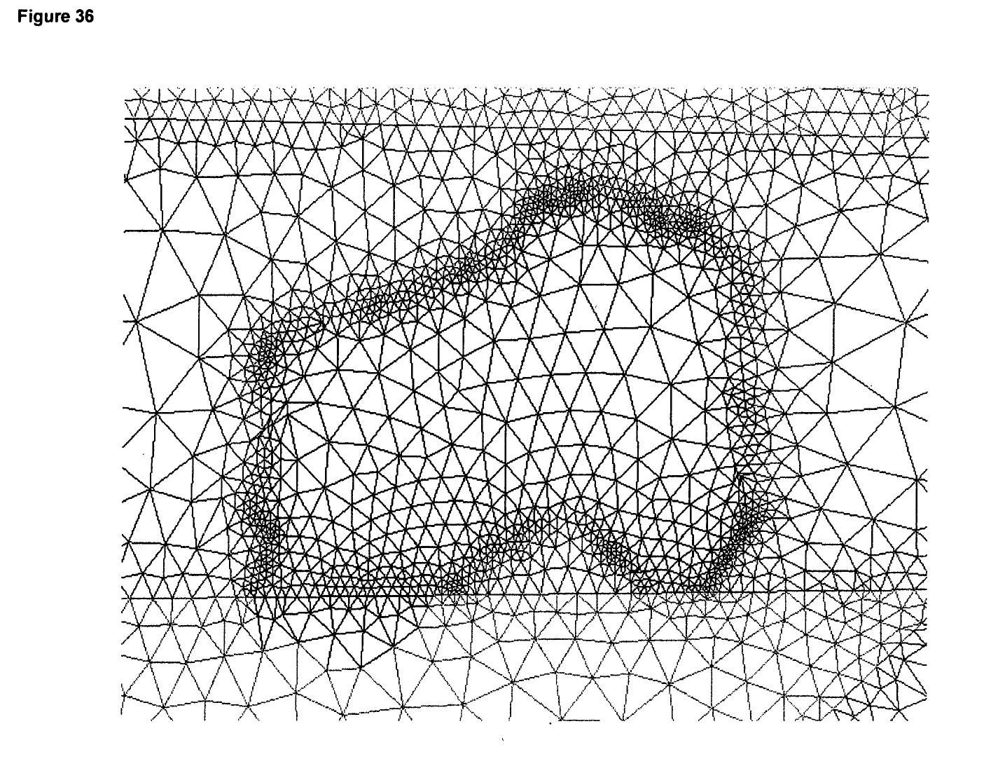

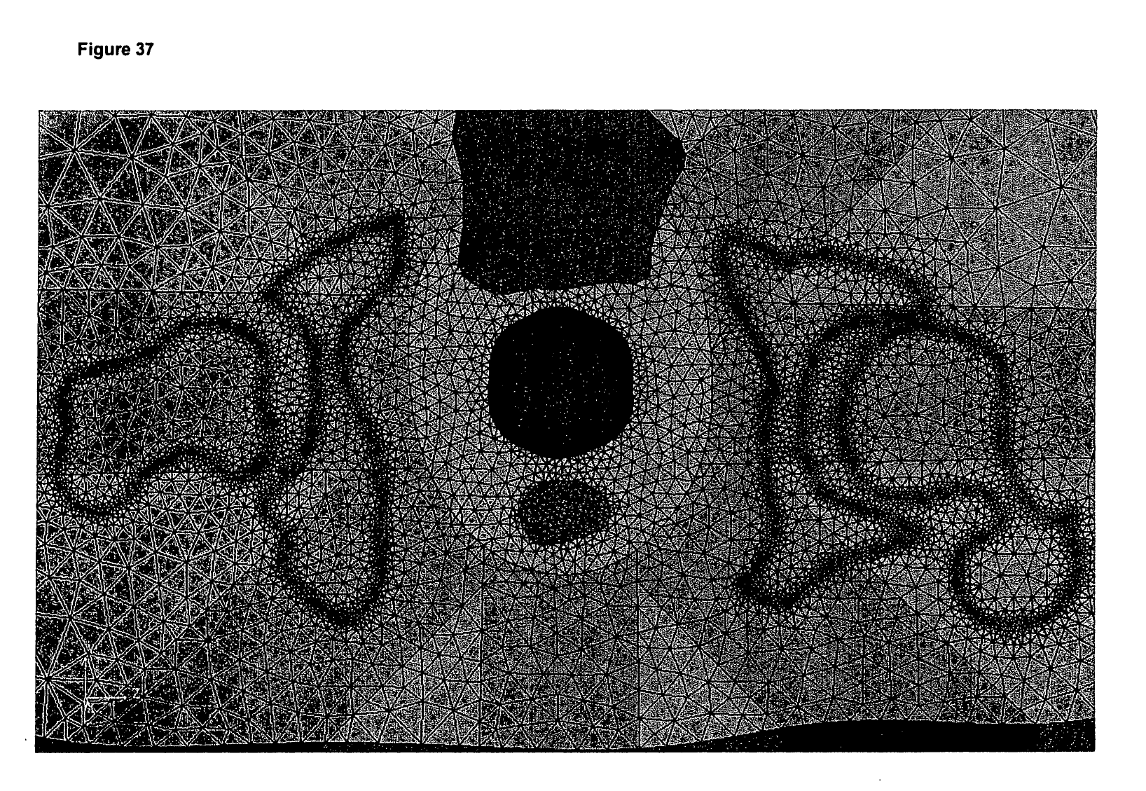

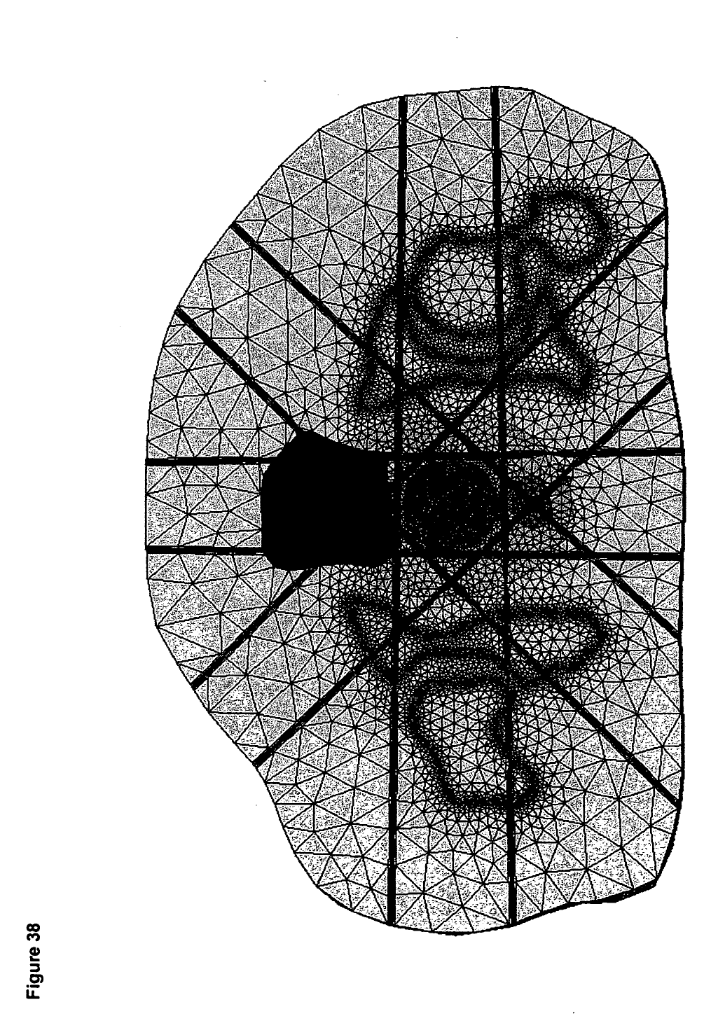

FIGS. 32 through 36 illustrate the progression of adaptation. The Cartesian grid is representative of a pixilated representation identifying a region of different composition, such as a bone. The perimeter of this grid, therefore, represents a material gradient. In the illustration provided, smoothing is performed at each adaptation step. The initial refinement step, shown in FIG. 33, is performed on the magnitude of the density, and all elements existing partially or fully within the perimeter are adapted. Subsequent adaptation steps, shown in FIGS. 34 through 36, are performed to resolve the gradients. As with other described adaptation steps, anisotropic adaptation may be a preferred embodiment, and may enable a further reduction in the number of elements needed to model the material gradients. As shown in FIG. 36, adaptation for elements within the beam perimeter is performed to a finer resolution than those external to the beam. FIGS. 37 and 38 illustrate sample meshes. In both cases, the local resolution is not dependent on proximity to the beams.

In brachytherapy treatments, radiation is generally delivered through sources that are either permanently implanted or temporarily inserted within catheters or various types of applicators. Some examples where applicators are used include intracavitary brachytherapy for gynecologic and rectal cancers, and balloon catheters for treating breast and brain cancers. These applicators often contain materials that may substantially perturb the local dose field distribution. In addition, inter-source shielding effects can also substantially influence the dose field when multiple sources are present. In order to accurately account for the perturbing effects, it is necessary to resolve relevant applicator and source features explicitly in the computational domain. Many of the processes described for external beam dose calculations are directly applicable to brachytherapy.

The process used to specify the VOIs in brachytherapy are largely identical to those used for external beam applications. Contoured structures such as the PTV and OARs may be converted to a surface representation suitable for mesh generation.

Since sources in brachytherapy are generally localized, it is rarely necessary to compute the dose calculation on the full extents of the patient image data. To that end, it may be advantageous to define an external domain boundary for the transport calculation, or at least limit the number of computational elements outside the regions where the dose may be significant. This may be performed in many ways, some of which include: (1) manual contouring of a domain boundary as was done for the CDR with external beams, using the bounding perimeter for the mesh generation process; (2) automated definition of a domain boundary, either before or after the mesh generation process, based on a threshold distance, the particle mean free path from the nearest source, or on any number of other considerations; (3) use the first collided source dose to selectively disable elements for which the first collided source, determined by ray tracing, is less than a threshold amount; and (4) regardless of the method, limiting the transport computations to those areas receiving a clinically significant dose.

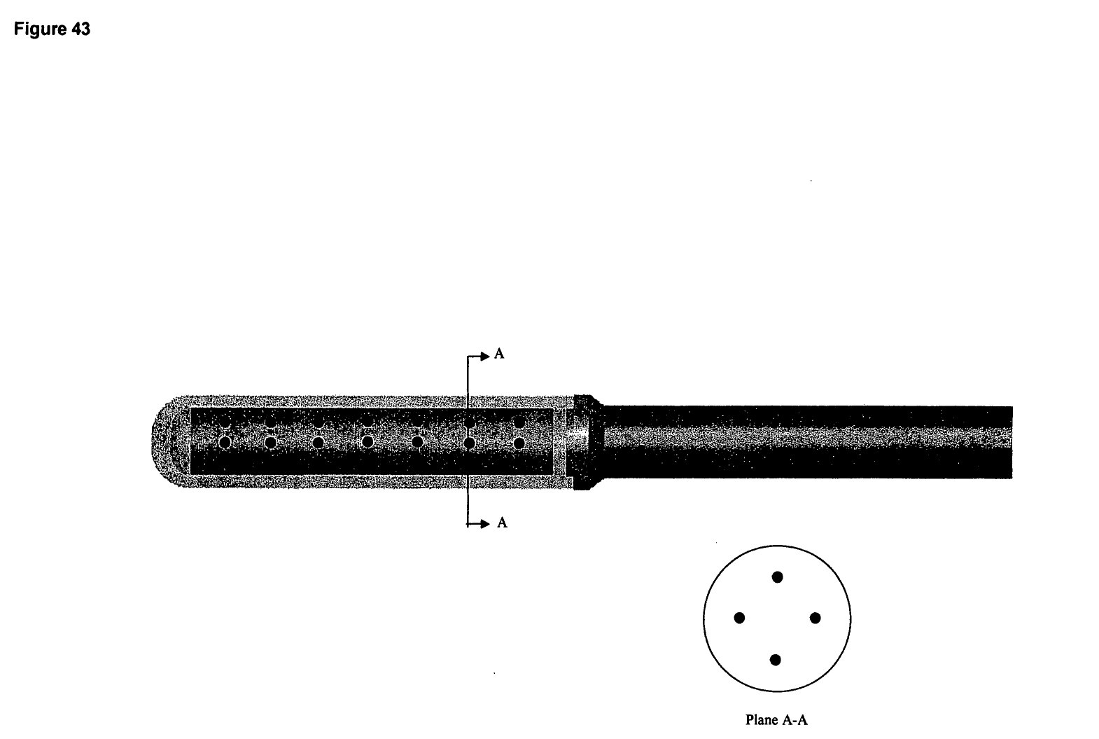

In a preferred embodiment, a computational mesh for non-anatomical components, such as applicators or sources, may be pre-generated. That is, an optimized tetrahedral mesh for the applicator may be created prior to analysis, which may include source positions explicitly modeled for all potential locations. For a given treatment specification, the material properties of any individual source position may be modified as appropriate to reflect either an active source, an dummy source such as a spacer, or a vacant position. FIG. 43 illustrates creation of an optimized tetrahedral mesh for the applicator. Since sources may include more than one material region, all regions can be modeled for each source position. Using the above-described process, a single, pre-generated computational mesh may be used for a broad range of treatment specifications for a given applicator-source type combination. Alternatively, the computational mesh could be created for part or all of the applicator for each specific treatment. This may be preferred for applications where movable shields are present, and it is possible to pre-generate computational meshes for all possible positioning scenarios.

The preferred process may be almost identical to that specified for external beams, with the exception of modeling an applicator and/or source components. Computational meshes of these components may be pre-generated. If this is done, the bounding faces and nodes of these components are merged with the surrounding anatomical mesh to ensure nodal connectivity. Alternatively, if pre-generated meshes are not created, surface representations of these components are used to ensure these features are modeled in the resulting computational mesh. This process is familiar to those skilled in the art of mesh generation.

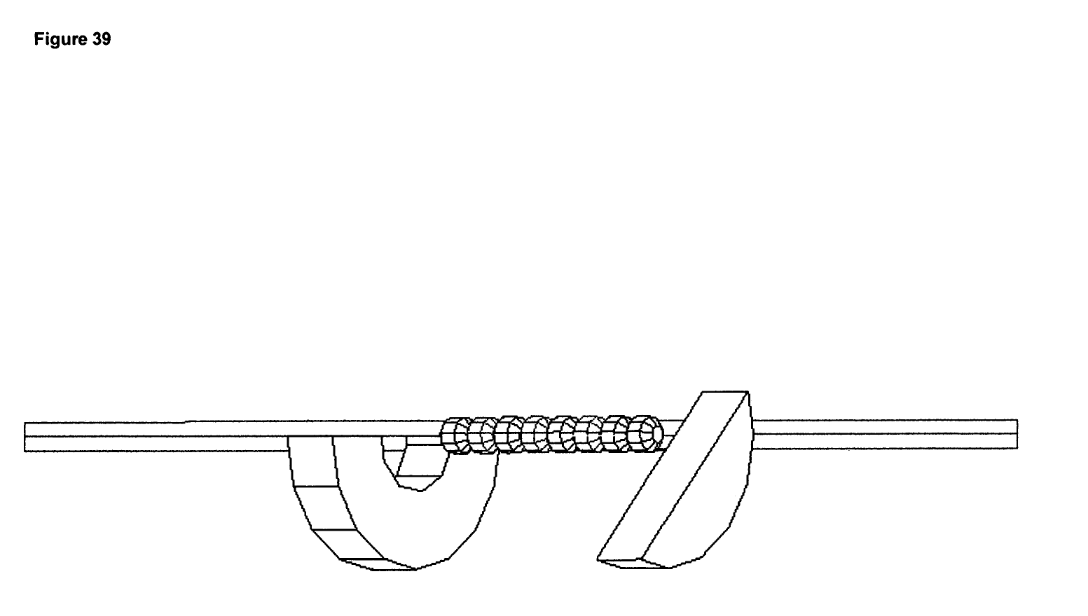

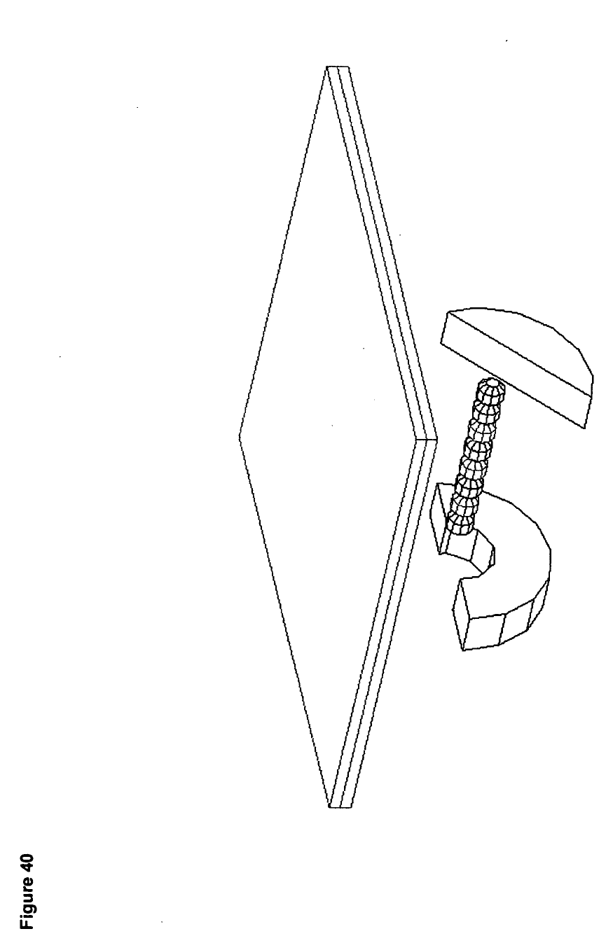

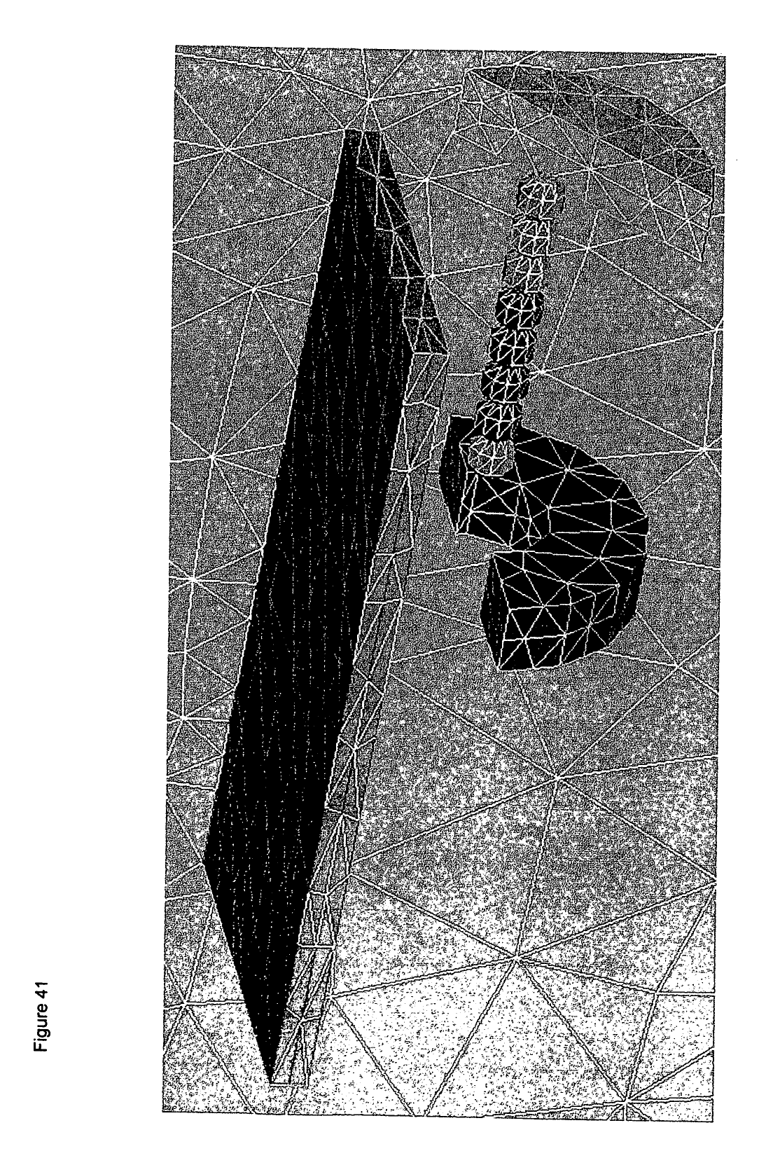

In certain cases, the orientation of the applicator relative to the sources may create gradients that are known prior to simulation. FIG. 39 illustrates gradients arising from applicator orientation. In FIG. 39, one of the shields is in the same position relative to the line of sight for all of the sources. Due to attenuation through the shield, a sharp gradient in the dose exists along this plane. To capture these gradients, techniques similar to those described above may be employed. These techniques may include isotropic or anisotropic adaptation based on the first collided source, or creation of one or more surfaces which constrain the mesh structure in the plane where the high gradient exists. FIG. 40 illustrate an alternative method in which several offset surfaces are created. FIG. 41 illustrates a resulting layered mesh structure. It should be noted that, for clarity, some of the applicator components have been removed from the computational mesh in FIG. 41. This can provide a high resolution normal to surfaces while maintaining large edge lengths in the other.

Radiation-Transport-Based Computation

The present invention includes the implementation of an unstructured solver that computes the solution to the Linear Boltzmann Transport Equations in three dimensions based on first-principle physics. For the purposes of this disclosure, the term “unstructured” refers to the capability of the solver to obtain a solution on a computational domain consisting of any combination of element shapes and types. This may include, but is not limited to, any combination of tetrahedral, hexahedral, prismatic, pyramidal, and polyhedral elements. These element types may also be linear or any higher order. Unstructured may also incorporate embedded (i.e. hanging node) localized refinement, which enables a step change in the element size by relaxing local nodal connectivity restraints, or completely arbitrary mesh interfaces. Elements may also be anisotropic, where the edge lengths are a function of the solution gradients.

A preferred embodiment uses tetrahedral elements for several reasons. For example, tetrahedral meshes may accommodate extreme spatial variations in element size. In other words, smaller elements may be used where the geometry and/or solution need them, and larger elements elsewhere. The result is a mesh structure which is highly efficient, as it may use a minimal number of elements. Additionally, tetrahedral elements may accurately capture complex geometry in a body fitted representation. Moreover, tetrahedral elements are well suited for solution based adaptive meshing algorithms. This is primarily due to the 3-noded faces on tetrahedral elements. As opposed to 4-noded faces, such as in hexahedral elements, face definitions are always uniquely defined, regardless of the level of element distortion. With 4-noded faces, face warpage may occur when elements are anisotropically modified to better approximate the geometry and/or solution.

For dose treatment planning, it is necessary to accurately determine the radiation energy deposited in the tissue. In order to determine the energy deposition, one needs to solve the linear Boltzmann transport equation (“LBTE”) for neutral particles (gamma rays or neutrons) and the linear Boltzmann-Fokker-Plank transport equation (“LBFPTE”) for charged particles (electrons, positrons, protons, and other ions). Methods used for numerically solving the LBTE or LBFPTE are described as “deterministic methods.”

Using the deterministic approach, one needs to numerically solve the LBTE for neutral particles or the LBFPTE for charged particles. We may describe the numerical techniques for each. The LBTE is given by,

$$\hat{Ω} \cdot \vec{∇} Ψ + {σ}_{t} Ψ = {\int }_{4 π} {{\int }_{0}}^{∞} {σ}_{s} ( {E}^{′} \to E , \hat{Ω} \cdot {\hat{Ω} }^{′} ) Ψ ⅆ {E}^{′} ⅆ {\hat{Ω} }^{′} + Q ,$$

where
Ψ=angular flux
σₜ=macroscopic total cross section
σₛ=macroscopic differential scattering cross section
Q=fixed source.

Here, Ψis a function of six independent variables: 3 in space (\vec{r}), 2 in angle (\hat{Ω}) and one in energy (E). This is a hyperbolic integro-differential equation. To solve the LBTE, we first discretize in angle using the discrete-ordinates, or Sn, method. The scattering source is expanded in spherical harmonics using the traditional form. The present invention employs the standard multigroup method in energy and discretizes, in space, using the discontinuous finite element method (DFEM) on unstructured tetrahedral grids. This spatial discretization may be expanded to other unstructured grids and higher order elements, such as quadratic or cubic, may be used. At present it appears that linear elements may suffice, but these equations may be solved with higher order elements if necessary for accuracy requirements. This may be necessary for some charged particle treatments, such as hadron therapy, where the flux may be deposited in a very localized spatial region.

To solve the discretized equations, we use the standard source iteration method accelerated with a diffusion synthetic acceleration (DSA) method.

The LBFPTE is given by

$$\begin{matrix}\hat{Ω} \cdot \vec{∇} Ψ + {σ}_{t} Ψ - \frac{\partial S Ψ}{\partial E} + {σ}_{t r} [ \frac{\partial }{\partial μ} ( 1 - {μ}^{2} ) \frac{\partial Ψ}{\partial μ} + \frac{1}{1 - {μ}^{2}} \frac{{\partial }^{2} Ψ}{{\partial }^{2} ϕ} ] = \\ {\int }_{4 π} {{\int }_{0}}^{∞} {σ}_{s} ( {E}^{′} \to E , \hat{Ω} \cdot {\hat{Ω} }^{′} ) Ψ ⅆ {E}^{′} ⅆ {\hat{Ω} }^{′} + Q ,\end{matrix}$$

where the first additional term added from the LBTE is the continuous slowing down operator and the second term is the momentum transfer operator. Here
S=stopping power
σₜᵣ=macroscopic momentum transfer cross section.

To solve this equation, one discretizes the streaming operator in angle using the discrete-ordinates method and the scattering source is expanded into spherical harmonics. The Galerkin scattering treatment is used to ensure integration of all spherical harmonic scattering moments. The angular momentum operator is discretized using a method known in the art. One discretizes over both space and energy using the linear DFEM. To use standard multigroup data for the scattering, all energy slope terms associated with the Boltzmann scattering operator are neglected. This results in a Boltzmann scattering treatment that is identical to the multigroup method but leaves all other terms with the full DFEM space-energy treatment. To solve the discretized equations, the source iteration method with DSA (diffusion synthetic acceleration) is used. The continuous slowing down term is treated like another spatial derivative in the sweeping process, so a space-energy sweep is performed. For charged particles, space and energy straggling of the beam may occur, which is essentially artificial numerical diffusion. To overcome this difficulty, higher order space-energy finite elements may be used in some applications. These may be implemented with the above algorithms. For both the LBTE and the LBFPTE, a first scattered distributed source may be used to more accurately preserve the beam as it is transported through the matter. In addition, one may obtain the adjoint solution to both the LBTE and the LBFPTE using our deterministic approach. Such solutions may be advantageous for inverse treatment planning processes. The spatial discretization scheme has a direct effect on solution accuracy and convergence behavior. The preferred embodiment incorporates a third-order accurate discontinous finite element spatial discretization (“DFEM”). The implementation of DFEM spatial discrefization provides several advantages for radiation therapy. A first advantage is that it enables an accurate capturing of the source beam, without numerical diffusion (i.e. smearing). A second advantage is that, through being discontinuous at the nodes, DFEM is able to accurately handle large gradients and step changes, which frequently occur at material boundaries. Since accurately capturing the dose immediately inside and around the tumor is of primary importance, this is a significant benefit. Third, DFEM is able to obtain a more accurate solution than traditional second order schemes, and provide much more reliable convergence behavior. Another advantage of DFEM is the solution is rigorously defined throughout the element, providing a unique solution at every location in the computational domain.

A known limitation of discrete-ordinate methods is that of ray effects, which are caused by solving the transport equation along a finite number of angles. One approach to mitigate ray effects is to compute, analytically, or by another means, such as Monte Carlo, the first collided source. This may then be used as input to a full transport calculation, and the final dose field is obtained by superimposing the solutions from the un-collided flux with the flux produced from the transport calculation.

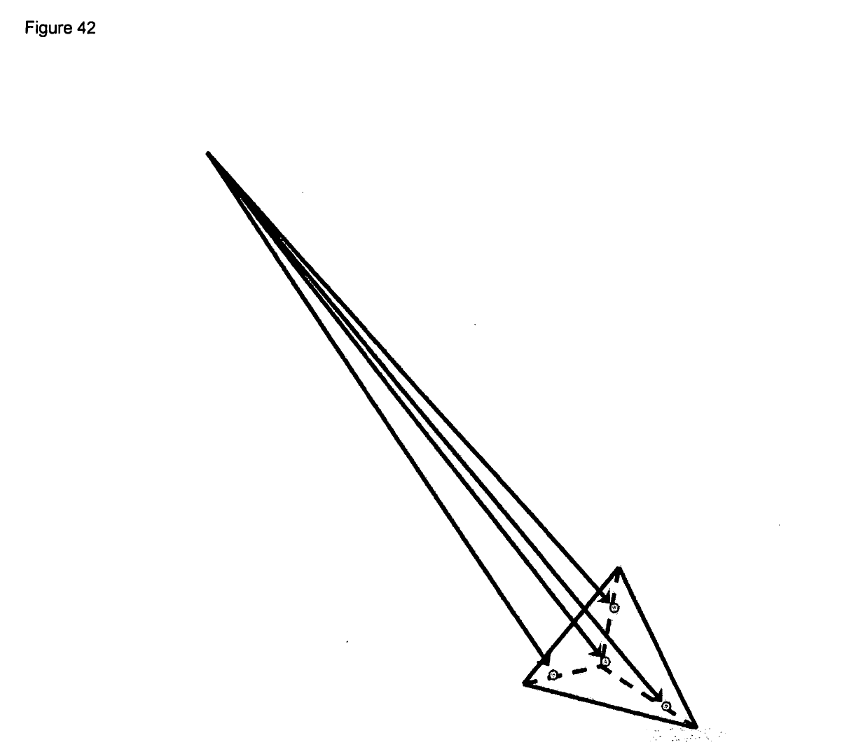

A preferred embodiment is to perform analytic ray tracing, to the Gaussian integration points on each element, rather than to the element nodes or centers as is commonly done. FIG. 42 illustrates analytic ray tracing to the Gaussian integration points on each element. This enables the first scattering source to be rigorously computed by using finite element integration rules on the cell.

Alternatively, the ray could be traced through the elements of any other problem related geometry deemed appropriate, for example the material and density map obtained from converting a pixilated image scan. This may be advantageous in that it will preserve the full resolution of the imaging process in the ray tracing calculation. The only output required from the tracking algorithm is the optical path length from source to quadrature point.

In a preferred embodiment, a four point quadratic Gaussian integration may be performed on linear tetrahedra. This produces a quadratic representation of the un-collided source within each element. Although the transport equation may be solved using a lower order, such as with a linear integration, a higher order representation of the un-collided flux can increase the total solution accuracy, especially in those cases where high gradients exist and the un-collided component represents a substantial percentage of the total flux. Other integration rules, potentially having a higher order, can also be used, along with other element types. The use of order higher order quadrature integration may require ray tracing to additional points on an element to allow exact finite element integration. Finite element quadrature rules are well known to those skilled in the art.

Adaptation can also be applied, where higher order ray tracing may be selectively performed based on the magnitude of local gradients from the initial uncollided flux calculation. This may incorporate a similar approach to that described for the mesh adaptation based on the un-collided flux. This can be useful in selectively improving the accuracy in areas of high source gradients, such as near beam perimeters, and/or may allow for a larger local element sizes without compromising accuracy.

Analytic ray tracing is well suited to mitigate ray effects in the uncollided flux, and produces a first collided source distribution. However, in many cases, secondary ray effects that may arise from the first collided source, or subsequent collisions, may also be significant. Although analytic ray tracing may be performed to mitigate ray effects, the distributed nature of the first collided source may likely make this approach inefficient. To mitigate these secondary ray effects, the preferred embodiment may calculate the first collided component, using a sufficiently large angular quadrature order. Here, the first collided source, obtained via ray tracing, is used as input, and only a single collision component is solved in the transport equation. Since each collision can be treated as a separate transport calculation, this can repeated multiple times as appropriate, where each subsequent calculation uses the collided source obtained from the previous collided component as input. Each subsequent calculation may also use a lower number of angles as appropriate. This approach may allow for the multiple iteration transport calculation, solving for the remaining collisions, to be performed with a lower angular quadrature order, which can substantially decrease the total computational time. The total flux, Ψ, is then obtained as follows:
Ψ=Ψ⁰+Ψ¹+Ψ²+ . . . Ψ^{∞}
where, Ψ⁰ is the uncollided flux, which may be obtained via ray tracing, and Ψ¹ through Ψ^{∞} represent the collided flux components obtained from each successive scattering event.

As an example, if Ψ¹ and Ψ² were obtained using single collision calculations, Ψ³ through Ψ^{∞} can be calculated to convergence using a multiple iteration transport calculation. If the single collision calculation is repeated a sufficient number of times, it may also not be necessary to perform a multiple iteration transport calculation.

The use of a single collision calculation, as described above, may be of benefit in many applications, and may be combined with methods to mitigate the uncollided source, such as analytic ray tracing. Alternatively, for some applications a single collision calculation may also be employed to mitigate ray effects from the uncollided source.

Numerous methods can be used to model anisotropic brachytherapy sources, all of which can be The preferred embodiment may to initiate the ray tracing for an isotropic source from a limited number of points that may be equally distributed throughout the source. An example of this is illustrated in FIG. 43, where 7 sets of 4 points are distributed along the axis.

In certain brachytherapy treatments, where a large number of sources exist, the ray tracing time may constitute a substantial component of the total dose calculation time. In such cases, it may be beneficial to use a single collision component calculation approach to calculate the first collided source using a high angular quadrature order.

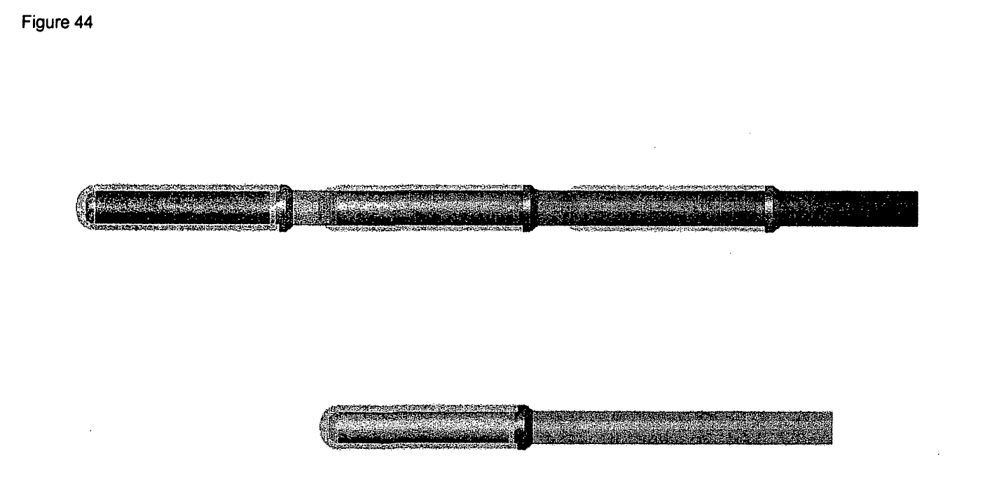

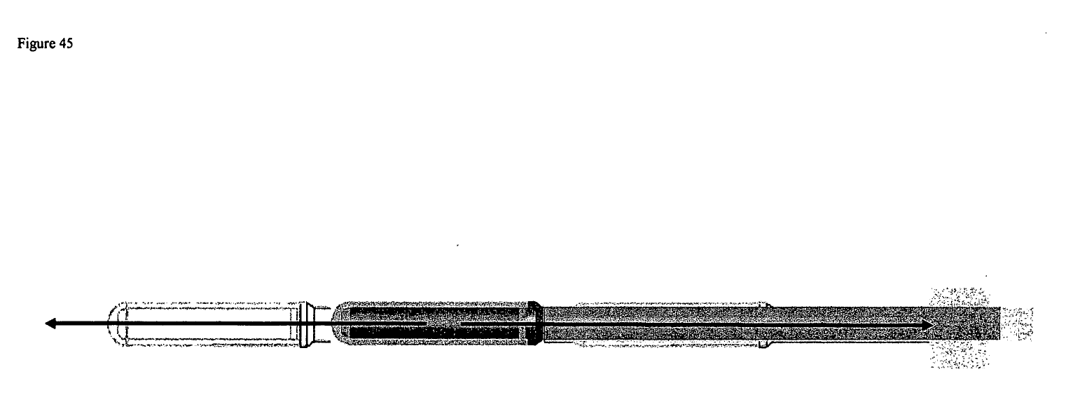

For delivery modes, such as high dose rate (“HDR”) and pulsed dose rate (“PDR”) brachytherapy, a single source may be attached to a cable, where its position is incrementally adjusted during the course of a treatment. Since a treatment may include numerous source positions, a preferred embodiment may be to perform a single dose calculation which includes all source positions. However, a complication may be introduced by explicitly modeling all sources simultaneously in a single calculation. More specifically, inter-source shielding may cause attenuations that are not physically present in the full calculation. FIG. 44 illustrates inter-source attenuation. By modeling all sources simultaneously, FIG. F44.A illustrates attenuation from a particle released from source B that is not physically present under true treatment conditions, which is shown in FIG. F44.B. Methods for mitigating inter-source attenuation may be employed. Ray tracing for the un-collided source for each source position may be performed, with the material properties of neighboring source positions modeled as air, or another appropriate low density medium. FIG. 45 illustrates a ray tracing approach to mitigate inter-source attenuation. In FIG. 45, ray tracing for Source B is performed using the materials in Sources A and C, and the cable to the left of Source B is changed to a low density medium. This process is repeated for each individual source. The transport calculation may then be performed with all source and cable materials explicitly modeled as appropriate.

For some brachytherapy treatments, it may be possible to calculate the dose field from potential individual source positions separately, followed by superimposing results of these calculations to create a cumulative dose field during treatment plan optimization. An example of this is for intracavitary brachytherapy, where applicator positioning may be known prior to treatment optimization. In such cases, a finite number of source positions may be possible, each of which may be calculated. The superposition principle can also be applied in this manner to vary the dwell times in each one of these sources.

Most of the above-described approaches illustrate examples for calculating the dose field on a single computational mesh, which may include all beams within a treatment. These same principles can be used to perform multiple calculations, each consisting of one or more beams, with a reduced computational domain. The completed dose field can then be obtained by superimposing the solution obtained by each of these separate computations, each one representing a different beam. Interpolation methods can then be used to provide an accurate representation of the final solution, perhaps by interpolation over to a different grid structure consisting of any element type, or combination thereof.

In some applications, usage of single collision calculations may be beneficial for transporting incident external beam sources into a patient. Once example is that of Tomotherapy, where a single treatment may be delivered through dozens of fan shaped beams. With a large number of beams, in some cases it may be more efficient to calculate the first collided source in a patient using a single collision calculation rather than ray tracing.

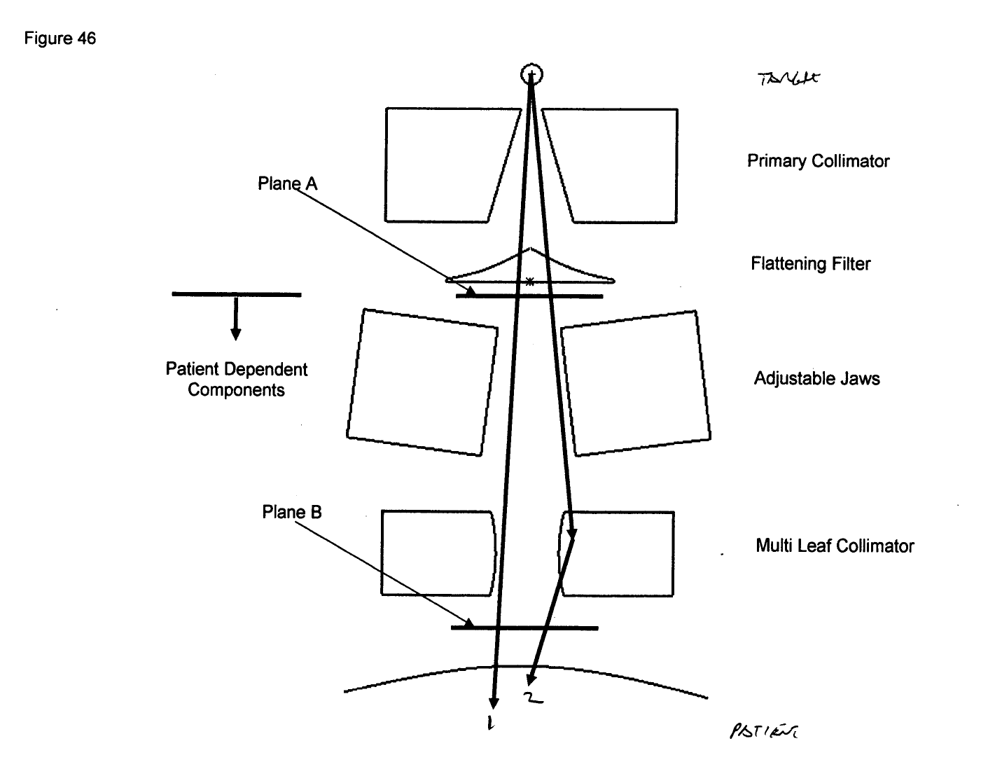

Another application involves scattering through treatment head components, such as field shaping devices, which may represent a substantial component of the total patient dose, such as in IMRT. In such cases, the incident fluence upon patient may be divided into uncollided and collided flux components. In this specific context, the term “collided flux” refers to components of the source which have undergone collisions in the field shaping devices, and thus, do not originate from a point source. FIG. 46 illustrates collided flux components. In FIG. 26, particle 1 proceeds through the field shaping devices without any collisions, and particle 2 undergoes a collision in the multi-leaf collimator. The source for any given patient plan can therefore be represented at plane B, which is located below the treatment head and above the patient. Alternatively, a single calculation including both treatment head components and the patient can be performed within a single calculation, removing the need for a source description to be defined at a location such as plane B. If described at a location such as plane B, the source resulting from particle transport through the field shaping devices may be determined using any number of available methods or approaches. The source description at plane B may include both collided and uncollided components. The same is true of a source representation at plane A, which is above the patient specific components of the field shaping devices. The uncollided component, the direction of which will trace back to the target, which is representative of a point source, may be calculated through the patient using any number of methods, the preferred embodiment being analytic ray tracing methods. The collided component may be modeled as a surface boundary condition, which is calculated using above-described methods to mitigate secondary ray effects.

If the calculation input is provided at plane B, the computational mesh may be extended external to the patient to include plane B, which may be necessary if the above-described methods, or an alternative transport calculation, is used to transport the collided component of the source into the patient. Alternatively, the methods described can be used to compute the patient specific treatment field through the treatment head, perhaps using either the solution phase space at plane A as input, or calculating the complete solution beginning at the target.

Adaptation may be performed for any number of parameters including, but not limited to, element size, edge length, material heterogeneities, angular quadrature order, polynomial expansion order to represent the scattering source, and the energy group structure and local convergence criteria. The level of adaptation may be based on any number of direct or derived quantities that may provide an estimate of the local errors and/or gradients within a solution. Many of the described methods incorporate methods of adaptation which can be employed prior to a multiple iteration transport solution. An alternative approach, which may be used in concert with those mentioned, is to iteratively adapt during the transport calculation. Here, the adaptation process may be performed one or more times, during the transport calculation, to optimize the solution speed and accuracy based on the desired resolution of specific quantities.

A number of options are available for the described methods which can further reduce the computational time, or increase accuracy, for the proposed methods. Some of these are described here. An initial guess of the solution is needed to begin the iterative solution process. The initial value may be supplied under user control as either some constant value or as a field read in from a disk file. This field may be generated in any manner desired, but is commonly the result of some previous solution. The use of a result from a previous similar calculation as starting guess may substantially reduce the amount of time needed to converge on the new solution. This may be especially valuable for increasing the speed of dose calculations during an optimization process, where it may be desired to run numerous calculations having small perturbations.

One method to reduce the computational time is to only perform the transport calculation, for any given particle type, on a subsection of the patient anatomy scanned during imaging. Although an initial computational mesh may, in many cases, be constructed on the full anatomy, elements can be selectively deactivated or removed for specific calculations. An example is for photon beam treatments, where secondary electrons may substantially influence the dose field, but due to their short mean free paths, and that the detailed transport solution may be needed everywhere in the imaged volume. CDR regions are created, in part, to define subsections where localized electron transport calculations may be performed. In these calculations, the electron source can be determined from the photon calculation, which can optionally be mapped to an alternative computational mesh, using interpolation schemes. In the case where multiple regions are defined, a separate electron transport calculation may be performed on each region. To improve solution accuracy and/or to reduce the number of computational elements in the electron transport calculation, albedo boundary conditions may be applied at the bounding faces of the transport grid. These boundary conditions may allow a certain fraction of the exiting flux to reenter with an isotropic profile. The methods described here, while mentioned specifically for electron transport, may also be applied to photon calculations, or any other particle type.

In a preferred embodiment, separate analysis settings may be applied to each particle type as appropriate. In some cases, this may necessitate using a separate computational mesh for each particle type. This allows, for example, electron calculations to be performed with a lower quadrature order than is required for photon particles.

The order of the polynomial expansion used to represent the scattering source may be varied in space and energy to further accelerate the computational solution speed. One means to perform this is to base the polynomial order on the specific computational region, such as VOI, CDR, beam path, etc., in which an element is located, in a manner similar to those processes used for adaptation of the computational mesh size.

If some geometrical regions of the model are not of interest, the iterative convergence in those areas may not have to be evaluated in determining overall solution convergence. A means to implement this may be through specification of a minimum threshold dose, which may be normalized by a quantity such as the maximum dose in the model. In computing the global convergence criteria, elements having a maximum dose less than this threshold may be ignored, or weighted appropriately.

Python Implementation

The following routine, with comments, includes the high level outline for radiation transport computation that represents one embodiment of the present invention. Additional routines of the illustrative Python implementation are included in Appendix A. These routines are well commented, and self explanatory to anyone familiar with radiation physics and computer programming.

Although the present invention has been described in terms of a particular embodiment, it is not intended that the invention be limited to this embodiment. Modifications within the spirit of the invention will be apparent to those skilled in the art.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for radiation dose calculation comprising:
preparing a computational model of a volume including a treatment target;
characterizing the radiation source;
providing parameters for the interaction of radiation with the tissues and materials through which the radiation passes; and
performing a discrete-ordinate, deterministic radiation-dose calculation for the characterized source, source position and geometry, and target model.
